(19) United States
(12) Patent Application Publication
(10) Pub. No.: US 2026/0317600 A1
(43) Pub. Date: Oct. 15, 2026

(54) REACTIVE ADHESIVE WITH IMPROVED OPEN TIME

(71) Applicant: Covestro Deutschland AG, Leverkusen (DE)

(72) Inventors: Christoph Thiebes, Köln (DE); Thomas Fait, Köln (DE); Zhirong Fan, Langenfeld (DE); Wolfgang Arndt, Dormagen (DE)

(21) Appl. No.: 19/485,317

(22) PCT Filed: May 17, 2024
(86) PCT No.: PCT/EP2024/063780

§ 371 Date: Nov. 18, 2025

(30) Foreign Application Priority Data
May 25, 2023 (EP) 23175386.4
Aug. 10, 2023 (EP) 23190786.6

(51) Int. Cl. C09J 175/06; C09J 5/06; C09J 11/08

(52) U.S. Cl. CPC C09J 175/06; C09J 5/06; C09J 11/08

(57) ABSTRACT

The invention relates to an aqueous adhesive formulation in the form of an aqueous dispersion containing at least the following dispersed components: (A) at least one polymer selected from the group consisting of polyurethane polymers, vinyl polymers, polyester polymers and/or mixtures of at least two thereof, the polymer having a partial acid number of <1.25 mg KOH/g determined in accordance with DIN EN ISO 2114:2000 (2002-06, Method A with an acetone-ethanol solvent mixture); (B) at least one semicrystalline or crystalline polyurethane polymer containing carboxyl groups which has a melting temperature in the range of 35 to 80° C., an enthalpy of fusion of ≥15 J/g, each determined by DSC (differential scanning calorimetry) at a heating rate of 20 K/min in accordance with DIN EN ISO 11357-1:2017 (2017-02), and has a partial acid number in the range from 1.25 mg KOH/g to 25 mg KOH/g, determined in accordance with DIN EN ISO 2114:2000 (2002-06, Method A with an acetone-ethanol solvent mixture); (C) at least one polycarbodiimide and/or at least one polyaziridine and/or a mixture thereof; and (D) optionally at least one further polymer other than the at least one polymer (A) and the at least one polyurethane polymer (B). It further relates to a corresponding kit-of-parts, to a process for producing the aqueous adhesive formulation, the uses of the adhesive formulation, and to articles that have been produced using the adhesive formulation.

The invention relates to an aqueous adhesive formulation in the form of an aqueous dispersion containing at least the following dispersed components: (A) at least one polymer selected from the group consisting of polyurethane polymers, vinyl polymers, polyester polymers and/or mixtures of at least two thereof, the polymer having a partial acid number of <1.25 mg KOH/g determined in accordance with DIN EN ISO 2114:2000 (2002-06, Method A with an acetone-ethanol solvent mixture); (B) at least one semicrystalline or crystalline polyurethane polymer containing carboxyl groups which has a melting temperature in the range of 35 to 80° C., an enthalpy of fusion of ≥15 J/g, each determined by DSC (differential scanning calorimetry) at a heating rate of 20 K/min in accordance with DIN EN ISO 11357-1:2017 (2017-02), and has a partial acid number in the range from 1.25 mg KOH/g to 25 mg KOH/g, determined in accordance with DIN EN ISO 2114:2000 (2002-06, Method A with an acetone-ethanol solvent mixture); (C) at least one polycarbodiimide and/or at least one polyaziridine and/or a mixture thereof; and (D) optionally at least one further polymer other than the at least one polymer (A) and the at least one polyurethane polymer (B). It further relates to a corresponding kit-of-parts, to a process for producing the aqueous adhesive formulation, the uses of the adhesive formulation, and to articles that have been produced using the adhesive formulation.

Adhesives based on aqueous polyurethane dispersions have become established worldwide in demanding industrial uses, for example in shoe manufacture, in the bonding of furniture parts, in the bonding of parts for motor vehicle interiors, in sheet lamination or in the bonding of textile substrates. The production of aqueous polyurethane or polyurethane-polyurea dispersions is known.

In the case of the use of such dispersions for bonding substrates, this is usually carried out after the heat-activation process. In this method, the dispersion is applied to the substrate and, once the water has completely evaporated, the adhesive layer is activated by heating, for example using an infrared radiator, and is converted into an adhesive state. The temperature at which the adhesive film becomes tacky is referred to as the activation temperature. The adhesives used in these methods in many cases contain crystalline components that are in molten form at or above the activation temperature.

Adhesives based on aqueous polyurethane or polyurethane-polyurea dispersions that are suitable for the use of the thermal activation method are described in U.S. Pat. No. 4,870,129. Accordingly, by use of specific mixtures of diisocyanates and polyol components by the acetone method, it is possible to obtain aqueous polyurethane or polyurethane-urea dispersions. The films obtainable therefrom have good activatability.

However, when using polyurethane dispersions or polyurethane-polyurea dispersions, it is also possible to work by the wet-bonding method, meaning that bonding follows immediately after application of the adhesive. The parts to be joined need to be mechanically fixed in place until the adhesive has set. This method is often used for the bonding of wood or textile substrates.

U.S. Pat. No. 4,870,129A discloses an adhesive containing a crosslinker containing isocyanate groups and an aqueous polyurethane dispersion containing hydroxyl groups, wherein the crosslinker increases the crosslinking density of the adhesive and hence improves the hydrolysis stability of the coating formed therefrom. It is disadvantageous, however, that the crosslinking reaction of the isocyanate groups with water and hydroxyl groups sets in immediately after the production of the adhesives, and these adhesives therefore have only a short processing time, generally of a few hours. This is unfavourable because any unused adhesives produced can no longer be used after the pot life has elapsed.

U.S. Pat. No. 6,348,548 discloses the use of an aqueous dispersion containing at least one solid surface-passivated polyisocyanate and at least one isocyanate-reactive polymer for production of a potentially active layer or a powder with storage stability. A disadvantage of this course of action is that it requires heating over a long period at high temperature for activation once the components mentioned have been applied to a substrate surface. It is therefore also unsuitable for the bonding of substrates that can be damaged by heating to elevated temperatures.

WO2020035573A1 describes an adhesive formulation consisting of at least one polyurethane dispersion, a surface-deactivated solid isocyanate and a polycarbodiimide. Activation temperatures can be lowered in this case, but the use of surface-deactivated solid isocyanates is economically disadvantageous because these are difficult to produce and costly. Moreover, for production-related reasons, these usually contain residual monomers of diisocyanates that are undesirable for reasons of occupational hygiene.

Both US2011/0244228 and CN106916273 disclose an aqueous polyurethane dispersion containing terminal and pendant carboxyl groups. The aqueous polyurethane dispersion can be crosslinked with polycarbodiimides in order to increase the heat resistance of the coating formed from the aqueous polyurethane dispersion. There is no explicit mention of specific blends with polymers not containing carboxyl groups.

Crosslinking is effected by reaction of the carboxyl groups in the polyurethane polymer with the carbodiimide groups in the polycarbodiimide after film formation. This is described, for example, in Meier-Westhues et al. Polyurethanes, 2nd edition, Vincentz Network Hanover, 2019, pages 342-343. The “open time” is reported here as “~1 h”.

EP2186841A1 describes dispersed polyurethanes or polyurethane-polyureas having terminal carboxyl groups and additionally pendant sulfonate and/or carboxylate groups. The focus of the patent lies in the pendant position of the carboxyl and carboxylate groups. There is no explicit mention of blends with polymers not containing carboxyl groups.

A general drawback in the case of use of polyester-polyurethane dispersions containing carboxyl groups is the elevated tendency to hydrolysis of the polyester groups, which is catalysed by the carboxyl groups, especially at high temperatures. The resultant decrease in molecular weight leads to reduced heat resistances in application. As a result, these products should be stored at temperatures below 30° C. and be used as quickly as possible.

Mixtures of polyurethane dispersions are known. For example, U.S. Pat. No. 6,797,764B2 describes mixtures of specific polyester-based polyurethane dispersions containing sulfonate groups and aqueous aliphatic polyurethane dispersions. These have good adhesion to a multitude of metal and plastic substrates after thermal activation. There is no mention of crosslinking with polycarbodiimides or polyaziridines.

US20160168434A1 describes an adhesive formulation consisting of a mixture of a polyurethane dispersion 1 containing a polyurethane having isocyanate-reactive groups and a polyurethane dispersion 2 containing a polyurethane having carboxyl groups and further isocyanate-reactive groups, and a surface-deactivated solid isocyanate. The use of the surface-deactivated solid isocyanate in the adhesive formulations is necessary to be able to achieve good adhesion to metallic substrates. The use of polyurethane dispersions containing carboxyl groups is described; there is no mention of simultaneous use of crosslinkers that can react with acid groups. The aim of the use of polyurethanes containing carboxyl groups is improved adhesion on metallic substrates. A very high concentration of carboxyl groups is needed to achieve the desired effect.

US20220177751A1 describes latently reactive adhesives based on crystalline polyurethane dispersions and solid polycarbodiimides. There is no explicit discussion of the use of polymer dispersions not containing carboxyl groups alongside those that do contain carboxyl groups. Because of the tendency to sedimentation in dispersion and blocking during storage, the processing and use of solid polycarbodiimides is disadvantageous.

It was therefore an object of the present invention to provide aqueous polyurethane-based adhesives that are suitable for use in thermal activation methods with low activation temperatures and durations, lead to particularly heat-resistant bonds and overcome the disadvantages of the prior art in that they have a long pot life and open time and do not require the use of surface-deactivated solid polyisocyanates, and work with a reduced proportion of polyester-polyurethane dispersions containing carboxylic acid groups.

This object is achieved by the aqueous adhesive formulation according to the invention, in the form of an aqueous dispersion containing at least the following dispersed components:
(A) at least one polymer selected from the group consisting of polyurethane polymers, vinyl polymers, polyester polymers and/or mixtures of at least two thereof, the polymer having a partial acid number of <1.25 mg KOH/g determined in accordance with DIN EN ISO 2114:2000 (2002-06, Method A with an acetone-ethanol solvent mixture);
(B) at least one semicrystalline or crystalline polyurethane polymer containing carboxyl groups which has a melting temperature in the range of 35 to 80° C., an enthalpy of fusion of ≥15 J/g, each determined by DSC (differential scanning calorimetry) at a heating rate of 20 K/min in accordance with DIN EN ISO 11357-1:2017 (2017-02), and has a partial acid number in the range from 1.25 mg KOH/g to 25 mg KOH/g, determined in accordance with DIN EN ISO 2114:2000 (2002-06, Method A with an acetone-ethanol solvent mixture);
(C) at least one polycarbodiimide and/or at least one polyaziridine and/or a mixture thereof; and
(D) optionally at least one further polymer other than the at least one polymer (A) and the at least one polyurethane polymer (B).

This object is likewise achieved by the kit-of-parts according to the invention for production of an adhesive formulation comprising the following components:
(A) at least one polymer selected from the group consisting of polyurethane polymers, vinyl polymers, polyester polymers and/or mixtures of at least two thereof, the polymer having a partial acid number of <1.25 mg KOH/g determined in accordance with DIN EN ISO 2114:2000 (2002-06, Method A with an acetone-ethanol solvent mixture);
(B) at least one semicrystalline or crystalline polyurethane polymer containing carboxyl groups which has a melting temperature in the range of 35 to 80° C., an enthalpy of fusion of ≥15 J/g, each determined by DSC (differential scanning calorimetry) at a heating rate of 20 K/min in accordance with DIN EN ISO 11357-1:2017 (2017-02), and has a partial acid number in the range from 1.25 mg KOH/g to 25 mg KOH/g, determined in accordance with DIN EN ISO 2114:2000 (2002-06, Method A with an acetone-ethanol solvent mixture);
(C) at least one polycarbodiimide, at least one polyaziridine and/or a mixture thereof; and
(D) optionally at least one further polymer other than the at least one polymer (A) and the at least one polyurethane polymer (B).

It has been found that, surprisingly, the described adhesive formulations according to the invention, consisting of or containing aqueous polymer dispersions, preferably aqueous polyurethane or polyurethane-polyurea dispersions, in combination with at least one polycarbodiimide, are suitable as adhesives by the thermal activation method and have an open time of several days to weeks. It has also been found that, surprisingly, the kit-of-parts according to the invention can be used to produce an adhesive formulation according to the invention.

It has likewise been found that, surprisingly, storage-stable preliminary coatings of substrate surfaces, self-supporting latently reactive adhesive films or reactive adhesive powders can be produced with the adhesive formulations according to the invention. One result of this is that it is possible to fulfil the urgent wish in the processing industry to spatially and temporally separate the application of adhesive and the joining process.

The word “a” in the context of the present invention in association with countable parameters should be understood to mean the number “one” only when this is stated explicitly (for instance by the expression “exactly one”). When reference is made hereinbelow for example to “a polyisocyanate”, the word “a” should be regarded merely as the indefinite article and not the number one; this also therefore encompasses an embodiment in which two or more, for example structurally dissimilar, polyisocyanates are present.

“Polyurethane polymer” in the context of the invention means both polyurethane polymers and polyurethaneurea polymers or polyurethane-polyurea polymers.

“Aqueous dispersion” in the context of the invention means an aqueous dispersion, aqueous emulsion, aqueous suspension, or an intermediate state/intermediate form thereof, preferably an aqueous dispersion, aqueous emulsion and/or aqueous suspension.

More preferably, the term “dispersion” means an aqueous emulsion and/or an aqueous suspension. The term “polyurethane dispersion” refers both to polyurethane dispersions and polyurethane-(poly)urea dispersions.

“Open time” in the context of the invention means the time after the drying of an adhesive during which the adhesive is still capable of sufficient flow under the customary conditions in heat-induced bonding and wetting of a substrate to be bonded is still possible under moderate pressure, such that, for example, a high bond strength of bonded substrates can be achieved.

In the context of the invention, it is a feature of storage-stable preliminary coatings on substrate surfaces, self-supporting latently reactive adhesive films or reactive adhesive powders that, after storage under standard conditions (23° C., 50% relative humidity) after more than 24 h, more preferably after more than 7 d, they are still capable of sufficient flow under the customary conditions in heat-induced bonding, and wetting of a substrate to be bonded is still possible under moderate pressure.

Typically, in heat-induced bonding, the adhesive is heated to a temperature between 4° and 120° C., and the substrates are pressed with a moderate pressure, for example 0.5 to 10 bar.

According to the invention, a polymer, especially polyurethane polymer, is referred to as being semicrystalline or crystalline when it has a melting peak in the first heating run in DSC analysis according to DIN EN ISO 11357-1:2017 (2017-02) at a heating rate of 20 K/minute. The melting peak is caused by the melting of regular substructures in the polymer, especially polyurethane polymer. According to the invention, a polymer, especially polyurethane polymer, is referred to as being semicrystalline when it has a melting peak in the first heating run and has a glass transition in the third heating run in DSC analysis according to DIN EN ISO 11357-1:2017 (2017-02) at a heating rate of 20 K/minute.

The melting temperature of the at least one polyurethane polymer (B) present in the formulation of the invention is in the range from 35 to 80° C., preferably 40 to 70° C., more preferably 42 to 55° C. The enthalpy of fusion of the at least one polyurethane polymer (B) is ≥15 J/g. The at least one polymer (A), preferably polyurethane polymer (A), preferably has a glass transition temperature of in the range from −100° C. to 80° C., and, when the polymer (A) is preferably at least one semicrystalline polyurethane polymer (A), a melting temperature in the range from 35 to 80° C. and enthalpy of fusion of ≥15 J/g. Melting temperature and enthalpy of fusion are ascertained in the first heating run proceeding from a starting temperature of −100° C. in DSC analysis according to DIN EN ISO 11357-1:2017 (2017-02) at a heating rate of 20 K/min. The glass transition temperature is ascertained in the third heating run proceeding from a starting temperature of −100° C. in DSC analysis according to DIN EN ISO 11357-1:2017 (2017-02) at a heating rate of 20 K/min. In the case of application of DIN EN ISO 11357-1:2017, the part of the standard concerning determination of the glass transition temperature is DIN EN ISO 11357-2:2020-08, and the part of the standard concerning determination of melting temperature and enthalpy of fusion is DIN EN ISO 11357-3:2018-07. For the DSC analysis of polymers in aqueous dispersion, a sample is taken from a polymer film that has been dried to constant weight at 23° C. and 50% relative humidity and then stored in a drying box at 0% relative humidity for 3 days.

According to the invention, the expressions “comprising” or “containing” preferably mean “consisting essentially of” and more preferably mean “consisting of”. It should be noted that the features adduced individually in the claims can be combined with one another in any technically useful way (even across category boundaries, for example between method and device) and demonstrate further configurations of the invention. The description additionally characterizes and specifies the invention.

It should also be noted that any conjunction “and/or” used herein between two features and linking them to one another should always be interpreted such that in a first configuration of the subject matter of the invention only the first feature can be present, in a second configuration only the second feature can be present, and in a third configuration both the first and the second feature can be present.

In a preferred embodiment, the aqueous adhesive formulation according to the invention has a partial acid number in the range from 0.5 mg KOH/g to 10 mg KOH/g, preferably in the range from 1.0 mg KOH/g to 10 mg KOH/g, more preferably in the range from 2 mg KOH/g to 6 mg KOH/g, determined in accordance with DIN EN ISO 2114:2000 (2002-06, Method A with an acetone-ethanol solvent mixture).

In a preferred embodiment, the aqueous adhesive formulation according to the invention contains
(A) 5% by weight to 85% by weight, preferably 27% by weight to 80% by weight, of component (A),
(B) 10% by weight to 70% by weight, preferably 17% by weight to 70% by weight, of component (B),
(C) 1% by weight to 30% by weight, preferably 3% by weight to 20% by weight, of component (C), and
(D) 0% by weight to 30% by weight, preferably 0% by weight to 25% by weight, of component (D), where the proportions by weight of (A), (B), (C) and (D) add up to 100% by weight.

In a preferred embodiment, the sum total of the amounts of components (A), (B), (C) and optionally (D) in the aqueous adhesive formulation according to the invention is at least 30% by weight, preferably in the range from 30% by weight to 70% by weight, more preferably in the range from 35% by weight to 65% by weight, even more preferably in the range from 35% by weight to 65% by weight, based on the total weight of the aqueous adhesive formulation.

In a preferred embodiment, the aqueous adhesive formulation according to the invention also optionally contains at least one additive other than components (A), (B), (C) and (D).

In a preferred embodiment, the aqueous adhesive formulation according to the invention contains organic solvents in a concentration of ≤5% by weight, preferably ≤1% by weight, based on the total weight of the aqueous adhesive formulation. In a further preferred embodiment, the aqueous adhesive formulation according to the invention does not contain any acetone and/or organic polar aprotic solvents.

The individual components of the components present in the aqueous adhesive formulation according to the invention are described in detail below.

In a preferred embodiment, at least two of components (A), (B) and optionally (D) may be present collectively as a polymer hybrid, meaning that there are at least two different polymer chains in a particle that are not connected to one another (core-shell polymer particles). One example of a polymer hybrid is a polyurethane-vinyl polymer hybrid consisting partly of a polyurethane polymer and a polyacrylate polymer. In this example, depending on the polymer properties, the polyacrylate polymer would be component (A) or (D) and the polyurethane polymer would be component (A), (B) or (D). The polymer hybrid is preferably a polyurethane-vinyl polymer hybrid. Preferably, in a polyurethane-vinyl polymer hybrid, the vinyl polymer is component (A) and the polyurethane polymer is component (B), or the vinyl polymer is component (A) and the polyurethane polymer is component (D), or the vinyl polymer is component (D) and the polyurethane polymer is component (B). A polyurethane-vinyl polymer hybrid is obtainable, for example, by the in situ production of a vinyl polymer by polymerization of one or more vinyl monomers in the presence of a ready-made aqueous polyurethane dispersion. A polyurethane-vinyl polymer hybrid (also referred to hereinafter as polyurethane-vinyl polymer) is understood to mean that a vinyl polymer is prepared by free-radical polymerization of vinyl monomer(s) in the presence of the polyurethane or starting materials thereof, i.e. at least one polyisocyanate and at least one polyol. The vinyl monomer may be added before, during and/or after the preparation of the polyurethane. The vinyl monomer is polymerized by adding an initiator that affords free radicals, in order to polymerize the vinyl monomer, for example in the presence of the polyurethane. Suitable free-radical-forming initiators are well known in the art and include mixtures that are distributed between the aqueous and organic phases. A vinyl monomer in this connection does not mean a single vinyl monomer but an embodiment of a vinyl monomer, for example vinyl acetate.

### Component (A)

The aqueous adhesive formulation according to the invention and the kit-of-parts according to the invention contain, as component (A), at least one polymer selected from the group consisting of polyurethane polymers, vinyl polymers, polyester polymers and/or mixtures of at least two thereof, the polymer having a partial acid number of <1.25 mg KOH/g determined in accordance with DIN EN ISO 2114:2000 (2002-06, Method A with an acetone-ethanol solvent mixture).

If two or more polymers are present as component (A), the mixture of these polymers has an average partial acid number of <1.25 mg KOH/g, determined in accordance with DIN EN ISO 2114:2000 (2002-06, Method A with an acetone-ethanol solvent mixture), preferably where each of the polymers in the mixture has a partial acid number of <1.25 mg KOH/g, determined in accordance with DIN EN ISO 2114:2000 (2002-06, Method A with an acetone-ethanol solvent mixture).

In general, in the adhesive formulation according to the invention, it is possible to use any polymer known to the person skilled in the art which is selected from the group consisting of polyurethane polymers, vinyl polymers, polyester polymers and/or mixtures of at least two of these. Suitable vinyl polymers are all vinyl polymers that are known to the person skilled in the art and have a partial acid number of <1.25 mg KOH/g, determined in accordance with DIN EN ISO 2114:2000 (2002-06, Method A with an acetone-ethanol solvent mixture).

A “vinyl polymer” in the context of the invention means a polymer formed by addition polymerization [generally by a free-radical process] of at least one ethylenically unsaturated monomer. A vinyl monomer here thus means an ethylenically unsaturated monomer. Ethylenically unsaturated monomer(s) preferably include olefins such as ethylene or propylene, vinyl halides such as vinylidene chloride and vinyl chloride, ethylenically unsaturated amides, vinyl esters, vinyl ethers, ethylenically unsaturated nitriles, heterocyclic vinyl compounds, diesters of fumaric acid and maleic acid, mono- and diesters of itaconic acid, and especially esters of acrylic acid and methacrylic acid of the formula: CH₂═CR¹CO₂R² (1), where R¹ is H or methyl and R² is optionally substituted alkyl having 1 to 20 carbon atoms (preferably 1 to 8 carbon atoms) or cycloalkyl having 5 to 12 ring carbon atoms.

In a preferred embodiment, the vinyl polymer hybrid is a polyurethane-vinyl polymer hybrid. In another preferred embodiment, the vinyl polymer is not a vinyl polymer hybrid, and the term “vinyl polymer” does not include vinyl polymer hybrids.

More specific examples of such monomers for suitable vinyl polymers are alkyl esters such as methyl acrylate, ethyl acrylate, propyl acrylate, n-butyl acrylate, i-butyl acrylate, t-butyl acrylate, 2-octyl acrylate, 2-ethylhexyl acrylate, lauryl acrylate, isopropyl acrylate, cyclohexyl acrylate, methyl methacrylate, ethyl methacrylate, n-propyl methacrylate, isopropyl methacrylate, n-butyl methacrylate, i-butyl methacrylate, t-butyl methacrylate, cyclohexyl methacrylate, 2-ethylhexyl methacrylate, 2-octyl methacrylate, lauryl methacrylate, diethyl maleate, diethyl fumarate; vinyl esters such as allyl acetate, allyl chloroacetate, methallyl acetate, vinyl acetate, isopropenyl acetate; halides such as vinyl chloride, vinylidene chloride, allyl chloride, 1,2-dichloroprop-2-ene, methallyl chloride and trichloroethylene; nitriles such as acrylonitrile and methacrylonitrile; aryls such as styrene, α-methylstyrene, o-methylstyrene, m-methylstyrene, p-methylstyrene, pentachlorostyrene, o-chlorostyrene, m-chlorostyrene, p-chlorostyrene and p-cyanostyrene; conjugated dienes or chlorodienes such as butadiene and chloroprene; carbonyl-functional ethylenically unsaturated monomers such as acrolein, diacetoneacrylamide, vinyl methyl ketone, vinyl ethyl ketone, vinyl butyl ketone, diacetone acrylate and acetonitrile acrylate; hydroxy-functional alkyl (meth)acrylates (preferably 1 to 18C) such as 2-hydroxyethyl acrylate, 2-hydroxyethyl methacrylate, 2-hydroxy-n-propyl acrylate, 2-hydroxy-n-propyl methacrylate, 3-hydroxy-n-propyl methacrylate, 3-hydroxy-n-propyl acrylate, 4-hydroxy-n[1]butyl acrylate, 4-hydroxy-n-butyl methacrylate, hydroxystearyl acrylate, hydroxystearyl methacrylate; dihydroxyalkyl adducts (preferably 1 to 6 C) of maleic acid, fumaric acid and phthalic acid; polyethylene oxide- or polypropylene oxide-functionalized hydroxy-functional (meth)acrylates.

In particular, the following vinyl polymers are suitable: ethylene, butyl acrylate, methyl methacrylate, vinyl acetate and/or mixtures of at least two of these.

Suitable polyester polymers are all polyesters that are known to the person skilled in the art and have a partial acid number of <1.25 mg KOH/g, determined in accordance with DIN EN ISO 2114:2000 (2002-06, Method A with an acetone-ethanol solvent mixture). Suitable polyester polymers are obtainable, for example, by reaction of monomeric dicarboxylic acids with polyhydric alcohols. Particularly suitable formation components are aliphatic and aromatic dicarboxylic acids such as phthalic acid, terephthalic acid, isophthalic acid, adipic acid, sebacic acid, succinic acid, and butane-1,4-diol, hexane-1,6-diol and ethylene glycol.

Suitable polyurethane polymers are all the polyurethanes that are known to the person skilled in the art and have a partial acid number of <1.25 mg KOH/g, determined in accordance with DIN EN ISO 2114:2000 (2002-06, Method A with an acetone-ethanol solvent mixture). A polyurethane polymer suitable as component (A) is generally one or more polyurethanes in the narrower sense, i.e. polymers obtained by polymerization of polyols and polyisocyanates, but they may also be ones in which monoamines and/or diamines are used as formation components, optionally as chain extenders. In the context of the present invention, the polyurethane polymer of component (A) is thus generally at least one polyurethane, at least one polyurea and/or at least one polyurethaneurea.

The polyurethane polymers suitable as component (A) or the aqueous polyurethane or polyurethane urea dispersions thereof are typically reaction products of
a) at least one isocyanate-reactive component bearing at least one ionic or potentially ionic hydrophilic group,
b) at least one diol component and/or polyol component,
c) at least one di- and/or polyisocyanate component,
d) optionally at least one mono-, di- and/or tri-amino-functional compound and
e) optionally other isocyanate-reactive compounds.

Component a) is typically used in amounts of 0.5% by weight to 10% by weight, preferably 0.5% by weight to 4% by weight, based on the water- and solvent-free polyurethane or polyurethane-polyurea.

Component b) is typically used in amounts of 50% by weight to 95% by weight, preferably 65% by weight to 92% by weight, based on the water- and solvent-free polyurethane or polyurethane-polyurea.

Component c) is typically used in amounts of 4% by weight to 25% by weight, preferably 6% by weight to 15% by weight, based on the water- and solvent-free polyurethane or polyurethane-polyurea.

Component d) is typically used in amounts of 0% by weight to 10% by weight, preferably 0% by weight to 5% by weight, based on the water- and solvent-free polyurethane or polyurethane-polyurea.

Component e) is typically used in amounts of 0% by weight to 10% by weight, preferably 0% by weight to 5% by weight, based on the water- and solvent-free polyurethane or polyurethane-polyurea.

The proportions of components a), b), c), d) and e) add up to 100% by weight.

It will be apparent in the context of the invention that the above-described components a) to e) and the typical and preferred amounts thereof also include all combinations of the individually specified ranges of amounts with one another.

Suitable isocyanate-reactive components a) bearing at least one ionic or potentially ionic group are mono- and diaminocarboxylic acids, mono- and dihydroxysulfonic acids, mono- and diaminosulfonic acids, and also mono- and dihydroxyphosphonic acids or mono- and diaminophosphonic acids and alkali metal and ammonium salts thereof. Examples are N-(2-aminoethyl)-β-alanine, N-(2-aminoethyl)-2-aminoethanesulfonic acid, N-(2-aminoethyl)-2-aminoethanecarboxylic acid, ethylenediaminepropyl- or -butylsulfonic acid, propylene-1,2- or -1,3-diamine-β-ethylsulfonic acid, malic acid, citric acid, glycolic acid, lactic acid, glycine, alanine, taurine, lysine, 3,5-diaminobenzoic acid, an addition product of IPDI and acrylic acid (EP-A 0 916 647, example 1) and the alkali metal and/or ammonium salts thereof; the adduct of sodium bisulfite onto but-2-ene-1,4-diol, polyethersulfonate, the propoxylated adduct of 2-butenediol and NaHSO₃, described for example in DE-A 2 446 440 (pages 5-9, formulae I-III). Of good suitability for salt formation are sodium hydroxide, potassium hydroxide and/or lithium hydroxide, and tertiary amines such as triethylamine, dimethylcyclohexylamine and ethyldiisopropylamine. Other amines may also be used for salt formation, for example ammonia, diethanolamine, triethanolamine, dimethylethanolamine, methyldiethanolamine, aminomethylpropanol, and also mixtures of the specified and also other amines. It is advisable to add these amines only after the isocyanate groups have been largely converted.

Suitable isocyanate-reactive components a) bearing at least one ionic or potentially ionic group are also mono- and dihydroxycarboxylic acids, and alkali metal salts thereof. Examples are dimethylolpropionic acid, dimethylolbutyric acid, hydroxypivalic acid, and alkali metal salts thereof. Of good suitability for salt formation are sodium hydroxide, potassium hydroxide and/or lithium hydroxide.

The use of constituents having acid groups in a) that have not be neutralized, or been neutralized by weaker bases than KOH, is greatly limited in terms of use amount in accordance with the invention by the criterion that the partial acid number is <1.25 mg KOH/g.

The following condition is applicable to base-neutralized acid groups having the same strength as KOH:

Component a) is present in the polyurethane polymer suitable as component (A) preferably to an extent of 0.5% by weight to 10% by weight, preferably to an extent of 0.5% by weight to 4% by weight and more preferably to an extent of 0.5% by weight to 3.75% by weight, based on the total weight of the polyurethane polymer.

The polyurethane polymers suitable as component (A) are prepared from a polyol and a polyisocyanate. Examples of such polyols include polyester polyols, polyether polyols and combinations thereof. Suitable polyester polyols include crystallizing and amorphous polyester polyols.

Suitable diol and/or polyol components b) are compounds having at least two isocyanate-reactive hydrogen atoms and an average molecular weight of 62 to 18 000 and preferably 62 to 4000 g/mol. Examples of suitable formation components are polyethers, polyesters, polycarbonates, polylactones and polyamides. Preferred polyols b) have 2 to 4 and more preferably 2 to 3 hydroxyl groups. Mixtures of various such compounds are also possible.

Suitable polyester polyols are in particular linear polyester diols or also sparsely branched polyester polyols, as can be produced in a known manner from aliphatic, cycloaliphatic or aromatic di- or polycarboxylic acids such as succinic acid, methylsuccinic acid, glutaric acid, adipic acid, pimelic acid, suberic acid, azelaic acid, sebacic acid, nonanedicarboxylic acid, decanedicarboxylic acid, terephthalic acid, isophthalic acid, o-phthalic acid, tetrahydrophthalic acid, hexahydrophthalic acid, cyclohexanedicarboxylic acid, maleic acid, fumaric acid, malonic acid or trimellitic acid and acid anhydrides such as o-phthalic, trimellitic or succinic anhydride or mixtures thereof with polyhydric alcohols, such as ethanediol, di-, tri-, tetraethylene glycol, propane-1,2-diol, di-, tri-, tetrapropylene glycol, propane-1,3-diol, butane-1,4-diol, butane-1,3-diol, butane-2,3-diol, pentane-1,5-diol, hexane-1,6-diol, 2,2-dimethylpropane-1,3-diol, 1,4-dihydroxycyclohexane, 1,4-dimethylolcyclohexane, octane-1,8-diol, decane-1,10-diol, dodecane-1,12-diol or mixtures thereof, optionally with the additional use of higher-functional polyols such as trimethylolpropane, glycerol or pentaerythritol. Cycloaliphatic and/or aromatic di- and polyhydroxyl compounds are of course also suitable as polyhydric alcohols for producing the polyester polyols. In place of the free polycarboxylic acid, it is also possible to use for the production of the polyesters the corresponding polycarboxylic anhydrides or corresponding polycarboxylic esters of lower alcohols or mixtures thereof.

It will be apparent that the polyester polyols may also be homopolymers or copolymers of lactones, which are obtained preferably by adding lactones or lactone mixtures, such as butyrolactone, ε-caprolactone and/or methyl-ε-caprolactone, to the suitable di- and/or higher-functional starter molecules, such as the low molecular weight, polyhydric alcohols mentioned above as formation components for polyester polyols. Preference is given to the corresponding polymers of ε-caprolactone.

Particular preference is given to the largely linear polyesterpolyols which contain adipic acid and butane-1,4-diol and/or hexane-1,6-diol and/or 2,2-dimethylpropane-1,3-diol as formation components.

Likewise preferred are polyester polyols containing isophthalic acid and/or terephthalic acid, and neopentyl glycol, ethylene glycol, butanediol and/or hexanediol, as formation components.

Polycarbonates comprising hydroxyl groups are also suitable as polyhydroxyl components, for example those which can be produced by reacting diols, such as butane-1,4-diol and/or hexane-1,6-diol, with diaryl carbonates such as diphenyl carbonate, dialkyl carbonates such as dimethyl carbonate, or phosgene. The at least partial use of polycarbonates having hydroxyl groups can improve the resistance to hydrolysis of the polyurethane or polyurethane-urea dispersions.

Preference is given to polycarbonates which are prepared by reacting hexane-1,6-diol with dimethyl carbonate.

Examples of suitable polyether polyols are the polyaddition products of styrene oxides, of ethylene oxide, propylene oxide, tetrahydrofuran, butylene oxide, epichlorohydrin, and mixed addition and grafting products thereof, and also the polyether polyols obtained by condensation of polyhydric alcohols or mixtures of the same and obtained by alkoxylation of polyhydric alcohols, amines, and amino alcohols. Polyether polyols suitable as formation components A) are homopolymers, copolymers, and graft polymers of propylene oxide and of ethylene oxide that are obtainable by addition of the epoxides mentioned to low molecular weight diols or triols, such as those mentioned above as formation components for polyester polyols, or to higher-functional low molecular weight polyols such as pentaerythritol or sugar, or to water.

Particularly preferred difunctional or higher-functional polyols b) are polyester polyols, polylactones and polycarbonates.

Likewise suitable components b) are low molecular weight diols, triols, and/or tetraols, for example ethanediol, di-, tri-, tetraethylene glycol, propane-1,2-diol, di-, tri-, tetrapropylene glycol, propane-1,3-diol, butane-1,4-diol, butane-1,3-diol, butane-2,3-diol, pentane-1,5-diol, hexane-1,6-diol, 2,2-dimethylpropane-1,3-diol, 1,4-dihydroxycyclohexane, 1,4-dimethylolcyclohexane, octane-1,8-diol, decane-1,10-diol, dodecane-1,12-diol, neopentyl glycol, cyclohexane-1,4-diol, cyclohexane-1,4-dimethanol, 1,4-, 1,3-, 1,2-dihydroxybenzene or 2,2-bis(4-hydroxyphenyl)propane (bisphenol A), TCD diol, trimethylolpropane, glycerol, pentaerythritol, dipentaerythritol or mixtures thereof, optionally with additional use of other diols or triols not mentioned.

Polyols used may also be reaction products of the polyols mentioned, in particular of the low molecular weight polyols, with ethylene oxide and/or propylene oxide.

The low molecular weight components b) have a molecular weight of 62 to 400 g/mol and are preferably used in combination with the polyester polyols, polylactones, polyethers, and/or polycarbonates described above.

Polyol component b) is present in the polyurethane polymer suitable as component (A) preferably to an extent of 50% by weight to 95% by weight, preferably to an extent of 65% by weight to 92% by weight and more preferably to an extent of 75% by weight to 90% by weight, based on the total weight of the polyurethane polymer.

Suitable components c) include any desired organic compounds having at least two free isocyanate groups per molecule. Preference is given to using diisocyanates Y(NCO)₂ where Y is a divalent aliphatic hydrocarbyl radical having 4 to 12 carbon atoms, a divalent cycloaliphatic hydrocarbyl radical having 6 to 15 carbon atoms, a divalent aromatic hydrocarbyl radical having 6 to 15 carbon atoms or a divalent araliphatic hydrocarbyl radical having 7 to 15 carbon atoms. Examples of such diisocyanates that should be used with preference include tetramethylene diisocyanate, methylpentamethylene diisocyanate, hexamethylene diisocyanate, dodecamethylene diisocyanate, 1,4-diisocyanatocyclohexane, 1-isocyanato-3,3,5-trimethyl-5-isocyanatomethylcyclohexane, 4,4′-diisocyanatodicyclohexylmethane, 4,4′-diisocyanato-2,2-dicyclohexylpropane, 1,4-diisocyanatobenzene, 2,4-diisocyanatotoluene, 2,6-diisocyanatotoluene, 4,4′-diisocyanatodiphenylmethane, 2,2′- and 2,4′-diisocyanatodiphenylmethane, tetramethylxylylene diisocyanate, p-xylylene diisocyanate, p-isopropylidene diisocyanate, and mixtures consisting of these compounds.

It will be appreciated that it is also possible to additionally use proportions of higher-functionality polyisocyanates known per se in polyurethane chemistry, or else modified polyisocyanates known per se and for example comprising carbodiimide groups, allophanate groups, isocyanurate groups, urethane groups and/or biuret groups.

In addition to these simple diisocyanates, polyisocyanates containing heteroatoms in the radical linking the isocyanate groups and/or having a functionality of more than 2 isocyanate groups per molecule are also suitable. The former are, for example, polyisocyanates which have been produced by modification of simple aliphatic, cycloaliphatic, araliphatic and/or aromatic diisocyanates, are formed from at least two diisocyanates, and have a uretdione, isocyanurate, urethane, allophanate, biuret, carbodiimide, iminooxadiazinedione and/or oxadiazinetrione structure. An example of an unmodified polyisocyanate having more than 2 isocyanate groups per molecule is 4-isocyanatomethyloctane 1,8-diisocyanate (nonane triisocyanate).

Preferred diisocyanates c) are aliphatic and araliphatic diisocyanates such as hexamethylene diisocyanate, 1,4-diisocyanatocyclohexane, 1-isocyanato-3,3,5-trimethyl-5-isocyanatomethylcyclohexane, 4,4′-diisocyanatodicyclohexylmethane, 4,4′-diisocyanatodicyclohexylpropane-(2,2), and mixtures consisting of these compounds that may optionally contain proportions of 2,4-diisocyanatotoluene and/or 2,6-diisocyanatotoluene.

Very particularly preferred components c) are mixtures of hexamethylene diisocyanate and 1-isocyanato-3,3,5-trimethyl-5-isocyanatomethylcyclohexane, and mixtures of 1-isocyanato-3,3,5-trimethyl-5-isocyanatomethylcyclohexane and/or 4,4′-diisocyanatodicyclohexylmethane and/or 2,4-diisocyanatotoluene and/or 2,6-diisocyanatotoluene.

Component c) is present in the polyurethane polymer suitable as component (A) preferably in amounts of 4% by weight to 25% by weight, more preferably of 6% by weight to 15% by weight and especially preferably in amounts of 8% by weight to 15% by weight, based on the total weight of the polyurethane polymer.

Suitable components d) are mono-, di-, trifunctional amines and/or mono-, di-, trifunctional hydroxylamines, for example aliphatic and/or alicyclic primary and/or secondary monoamines such as ethylamine, diethylamine, the isomeric propyl- and butylamines, higher linear aliphatic monoamines and cycloaliphatic monoamines such as cyclohexylamine. Further examples are amino alcohols, i.e. compounds containing amino and hydroxyl groups in the same molecule, for example ethanolamine, N-methylethanolamine, diethanolamine, diisopropanolamine, 1,3-diamino-2-propanol, N-(2-hydroxyethyl)ethylenediamine, N,N-bis(2-hydroxyethyl)ethylenediamine, and 2-propanolamine. Further examples are diamines and triamines, such as ethane-1,2-diamine, hexamethylene-1,6-diamine, 1-amino-3,3,5-trimethyl-5-aminomethylcyclohexane (isophoronediamine), piperazine, 1,4-diaminocyclohexane, bis(4-aminocyclohexyl)methane, and diethylenetriamine. Also suitable are adipic dihydrazide, hydrazine and hydrazine hydrate. It will be appreciated that it is also possible to use mixtures of two or more of the compounds d) mentioned, optionally also together with ones that are not mentioned.

Preferred components d) are ethane-1,2-diamine, 1-amino-3,3,5-trimethyl-5-aminomethylcyclohexane, diethylenetriamine, diethanolamine, ethanolamine, N-(2-hydroxyethyl)ethylenediamine and N,N-bis(2-hydroxyethyl)ethylenediamine.

Components d) as chain extenders preferably serve to increase molecular weights to higher levels, or as monofunctional compounds to limit molecular weights and/or optionally additionally to incorporate additional reactive groups, for example free hydroxyl groups, as further crosslinking sites.

Component d) is present in the polyurethane polymer suitable as component (A) preferably in amounts of 0% by weight to 10% by weight, more preferably of 0% by weight to 5% by weight and especially preferably in amounts of 0.25% by weight to 4% by weight, based on the total weight of the polyurethane polymer.

Examples of difunctional polyol components having a molecular weight of 62 to 399 g/mol which are suitable as formation component e) include the polyols mentioned for the preparation of the polyester polyols b). Also suitable in principle are low molecular weight polyester diols, polyether diols, polycarbonate diols or other polymer diols, provided that they have a molecular weight of 62 to 399 g/mol.

Component e) is present in the polyurethane polymer suitable as component (A) preferably in amounts of 0% by weight to 10% by weight, more preferably of 0% by weight to 5% by weight, based on the total weight of the polyurethane polymer.

The additional use of component e) can result for example in polyurethane polymers containing other reactive groups in addition to the reactive groups present, which enables for example the use of different crosslinking mechanisms (dual cure) to achieve specific properties, for example a two-step curing process, optionally with a time interval between the steps, or a particularly high crosslinking density.

The polyurethane polymers suitable as component (A) may be present and used in solid form or as a dispersion in a liquid medium. The polyurethane polymers are preferably provided as aqueous dispersions. Such polyurethane dispersions suitable as component (A) preferably include nonvolatile fractions of 15% by weight to 70% by weight, preferably of 20% by weight to 60% by weight, based on the total weight of the aqueous polyurethane dispersion. The pH at 23° C. is preferably in the range from 4 to 11, more preferably 5 to 8. Average particle sizes measured by laser diffraction to ISO 13320 (laser diffraction) with the Malvern Mastersizer 3000 are typically in the range from 20 nm to 750 nm, preferably in the range from 30 nm to 450 nm.

Polyurethane or polyurethaneurea dispersions that are suitable as component (A) can be produced, for example, by reacting components a), b), c) and optionally e) in a one- or multistage reaction to give an isocyanate-functional prepolymer, which is then reacted with component d) in a one- or two-stage reaction and then dispersed in or with water, with optional partial or complete removal of any solvent used by distillation during or after the dispersion.

Polyurethane dispersions suitable as component (A) are preferably anionically stabilized polyurethane dispersions. One example of a commercially available polyurethane dispersion suitable as component (A) is Dispercoll® U 8755, available from Covestro Deutschland AG.

In a preferred embodiment, the at least one polymer (A) does not have any carboxyl groups and/or carboxylate groups.

In a preferred embodiment, the at least one polymer (A) is selected from the group consisting of polyurethane polymers, polyacrylate polymers, polymethacrylate polymers, polyvinylacetate polymers, polyester polymers and/or mixtures of at least two of these. The at least one polymer (A) is preferably selected from the group consisting of polyurethane polymers, polyacrylate polymers, polymethacrylate polymers and/or mixtures of at least two of these. In another preferred embodiment, the at least one polymer (A) is selected from the group consisting of polyurethane polymers, polyester polymers and/or mixtures of at least two of these. More preferably, the at least one polymer (A) is at least one polyurethane polymer.

In a preferred embodiment, the at least one polymer (A) has a partial acid number in the range from 0 mg KOH/g to 1 mg KOH/g, preferably in the range from 0 mg KOH/g to 0.05 mg KOH/g, in each case determined in accordance with DIN EN ISO 2114:2000 (2002-06, Method A with an acetone-ethanol solvent mixture).

In a preferred embodiment, the average molecular weight (Mw) of polymer (A)≥the average molecular weight (Mw) of polyurethane polymer (B), preferably wherein the average molecular weight (Mw) of polymer (A) is greater than the average molecular weight (Mw) of polyurethane polymer (B), in each case determined to DIN EN ISO 13885-2 (2021-11) with N,N-dimethylacetamide as eluent and polystyrene as standard.

In a preferred embodiment, the at least one polymer (A) has an average molecular weight (Mw) in the range from 70 000 g/mol to 350 000 g/mol, preferably in the range from 100 000 g/mol to 350 000 g/mol, more preferably in the range from 200 000 g/mol to 350 000 g/mol, even more preferably in the range from 300 000 g/mol to 350 000 g/mol, in each case determined in accordance with DIN EN ISO 13885-2 (2021-11) with N,N-dimethylacetamide as eluent and polystyrene as standard.

In a preferred embodiment, the at least one polymer (A) has a glass transition temperature of in the range from −100° C. to 80° C., determined by DSC (differential scanning calorimetry) DIN EN ISO 11357-1 (2017-02). In a further preferred embodiment, the at least one polymer (A) is at least one semicrystalline polyurethane polymer having a melting temperature in the range from 35 to 80° C. and an enthalpy of fusion of ≥15 J/g, in each case determined by DSC at a heating rate of 20 K/min to DIN EN ISO 11357-1:2017-02.

In a preferred embodiment, the proportion of component (A) in the aqueous adhesive formulation, based on total proportions of components (A), (B), (C) and (D) as 100% by weight, is 5% by weight to 85% by weight, preferably 27% by weight to 80% by weight, of component (A).

### Component (B)

The aqueous adhesive formulation according to the invention and the kit-of-parts according to the invention contain, as component (B), at least one semicrystalline or crystalline polyurethane polymer containing carboxyl groups which has a melting temperature in the range of 35 to 80° C., an enthalpy of fusion of ≥15 J/g, each determined by DSC (differential scanning calorimetry) at a heating rate of 20 K/min in accordance with DIN EN ISO 11357-1:2017 (2017-02), and has a partial acid number in the range from 1.25 mg KOH/g to 25 mg KOH/g, determined in accordance with DIN EN ISO 2114:2000 (2002-06, Method A with an acetone-ethanol solvent mixture).

In a preferred embodiment, the polyurethane suitable as component (B) has an enthalpy of fusion of ≥35 J/g, preferably of ≥40 J/g, more preferably of ≥45 J/g, in each case determined by DSC (differential scanning colorimetry) at a heating rate of 20 K/min in accordance with DIN EN ISO 11357-1:2017 (2017-02).

If two or more polymers are present as component (B), the mixture of these polymers has an average partial acid number in the range from 1.25 mg KOH/g to 25 mg KOH/g, determined in accordance with DIN EN ISO 2114:2000 (2002-06, Method A with an acetone-ethanol solvent mixture), preferably where each of the polymers in the mixture has a partial acid number in the range from 1.25 mg KOH/g to 25 mg KOH/g, determined in accordance with DIN EN ISO 2114:2000 (2002-06, Method A with an acetone-ethanol solvent mixture).

If two or more polymers are present as component (B), the mixture of these polymers has an average melting temperature in the range from 35 to 80° C. and an enthalpy of fusion of ≥15 J/g, in each case determined by DSC (differential scanning calorimetry) at a heating rate of 20 K/min in accordance with DIN EN ISO 11357-1:2017 (2017-02), where it is preferable that each of the polymers in the mixture has a melting temperature in the range from 35 to 80° C. and an enthalpy of fusion of ≥15 J/g, in each case determined by DSC (differential scanning calorimetry) at a heating rate of 20 K/min in accordance with DIN EN ISO 11357-1:2017 (2017-02).

In a preferred embodiment, the polyurethane suitable as component (B) is structurally different from polymer (A), especially the polyurethane suitable as component (A).

The polyurethane suitable as component (B) is preferably film-forming, preferably film-forming with a minimum film formation temperature according to DIN ISO 2115:2001-04 in the range from 0 to 100° C., more preferably between 0 and 35° C., and may, for example, be a single polyurethane containing carboxyl groups, or a mixture of at least two different polyurethanes containing carboxyl groups.

The crosslinking reaction with carbodiimide groups is preferably effected predominantly or exclusively via the incorporated carboxyl groups in the polyurethane suitable as component (B).

Suitable components (B) are all semicrystalline or crystalline polyurethane polymers containing carboxyl groups that are known to the person skilled in the art and have a melting temperature in the range of 35 to 80° C., an enthalpy of fusion of ≥15 J/g, each determined by DSC (differential scanning calorimetry) at a heating rate of 20 K/min in accordance with DIN EN ISO 11357-1:2017 (2017-02), and have a partial acid number in the range from 1.25 mg KOH/g to 25 mg KOH/g, determined in accordance with DIN EN ISO 2114:2000 (2002-06, Method A with an acetone-ethanol solvent mixture). A polyurethane polymer suitable as component (B) is generally one or more polyurethanes in the narrower sense, i.e. polymers obtained by polymerization of polyols and polyisocyanates, but they may also be ones in which monoamines and/or diamines are used as formation components, optionally as chain extenders. In the context of the present invention, the polyurethane polymer of component (B) is thus generally at least one polyurethane, at least one polyurea and/or at least one polyurethaneurea.

Components suitable in principle for formation of the polyurethane polymer suitable as component (B) are, for example, the above-described components a) to e) of the polyurethane polymer suitable as component (A).

In addition to the above-detailed components a) to e), the polyurethane polymer suitable as component (B) contains further components that are incorporated or have been incorporated into the polyurethane polymer (B). In particular, compounds having carboxyl groups and crystalline or semicrystalline difunctional polyester polyols have been incorporated into the polyurethane polymer (B).

Compounds containing carboxyl groups that are suitable as formation components for the polyurethane polymer (B) used in accordance with the invention as component (B) are, for example, diamino compounds or dihydroxyl compounds that additionally bear carboxyl groups. Examples of such compounds are dimethylolpropionic acid, dimethylolbutyric acid and/or reaction products of a Michael addition of 1 mol of diamine, for example ethane-1,2-diamine or isophoronediamine, with 2 mol of acrylic acid or maleic acid. These may additionally be used as component a) as described in the description of component (A).

More preferably suitable as unit containing carboxyl groups a) in component (B) is dimethylolpropionic acid.

Further compounds containing carboxyl groups that are suitable as component e) for the polyurethane polymer (B) used in accordance with the invention are, for example, aminocarboxylic acids that contain at least one isocyanate-reactive amino group, and hence are suitable for incorporation into the polymer in the preparation of the polyurethane polymers suitable as component (B) by reaction with component e). Linear aliphatic, branched aliphatic, aliphatic-aromatic, and aromatic aminocarboxylic acids are suitable. Examples of suitable compounds include aminocarboxylic acids having a primary or secondary amino group, such as alanine, lysine, glutamine, 6-aminohexanoic acid, aminoundecanoic acid, 8-aminooctanoic acid, 5-aminopentanoic acid, 4-aminobutyric acid, aminobenzoic acid, 4-aminomethylcyclohexanecarboxylic acid, 2-aminohexanoic acid, 4-aminocyclohexanecarboxylic acid, 12-aminododecanoic acid, 9-aminononacarboxylic acid.

Carboxyl group-containing units a) used in component (B) are preferably aminocarboxylic acids and more preferably aminoalkylcarboxylic acids such as 6-aminohexanoic acid and/or lysine, which are present in the polymer in a form incorporated via the amino group.

The units having carboxyl groups may partly also be used directly in their salt form or as carboxylate, or it is possible to add neutralizing agents that lead to salt formation only during or after production of the polyurethanes.

Examples of particularly suitable and preferred tertiary amines for salt formation are triethylamine, dimethylcyclohexylamine, and ethyldiisopropylamine. Particular preference is given to using triethylamine.

Other amines may also be used for salt formation, for example ammonia, diethanolamine, triethanolamine, dimethylethanolamine, methyldiethanolamine, aminomethylpropanol, and also mixtures of the specified and also other amines. It is advisable to add these amines only after the isocyanate groups have been largely converted.

It is also possible to use, for neutralization purposes, proportions of other neutralizing agents, for example sodium hydroxide, potassium hydroxide and/or lithium hydroxide. The type and amount of any neutralizing agents used should be chosen such that there are still carboxyl groups in the polymer used as component (B) when they are reacted with polycarbodiimides.

Useful crystalline or semicrystalline difunctional polyester polyols that are suitable as formation component b) in component (B) are in particular linear or else lightly branched polyester polyols based on dicarboxylic acids and/or derivatives thereof such as anhydrides, esters or acid chlorides and preferably aliphatic linear polyols. Mixtures of dicarboxylic acids and/or derivatives thereof are also suitable. Examples of suitable dicarboxylic acids are adipic acid, succinic acid, sebacic acid or dodecanedioic acid. Preference is given to succinic acid, adipic acid and sebacic acid and mixtures thereof, particular preference to succinic acid and adipic acid and mixtures thereof, and very particular preference to adipic acid. These are used in amounts of at least 90 mol %, preferably of 95 to 100 mol %, based on the total amount of all carboxylic acids.

The difunctional polyester polyols b) can be prepared for example by polycondensation of dicarboxylic acids with polyols. The polyols preferably have a molecular weight of 62 to 399 g/mol, consist of 2 to 12 carbon atoms, are preferably unbranched and difunctional, and preferably have primary OH groups.

Examples of polyols that may be used for the preparation of the polyester polyols b) include polyhydric alcohols, for example ethanediol, di-, tri-, or tetraethylene glycol, propane-1,2-diol, di-, tri-, or tetrapropylene glycol, propane-1,3-diol, butane-1,4-diol, butane-1,3-diol, butane-2,3-diol, pentane-1,5-diol, hexane-1,6-diol, 2,2-dimethylpropane-1,3-diol, 1,4-dihydroxycyclohexane, 1,4-dimethylolcyclohexane, octane-1,8-diol, decane-1,10-diol, dodecane-1,12-diol or mixtures thereof.

Preferred polyol components for the polyester polyols b) are ethane-1,2-diol, butane-1,4-diol and hexane-1,6-diol, particular preference being given to butane-1,4-diol and hexane-1,6-diol and very particular preference to butane-1,4-diol.

The polyester polyols b) may be formed from one or more polyols. In a preferred embodiment of the present invention, they are formed from just one polyol.

If the crystalline or semicrystalline difunctional polyester polyols having a number-average molecular weight of at least 400 g/mol and a melting temperature of at least 35° C. have an enthalpy of fusion of at least 50 J/g, the polymer prepared using these will regularly have an enthalpy of fusion of 15 J/g. If desired, adjustment of the enthalpy of fusion of the polymer can be achieved by a slight modification of the content of polyester polyol b) in the composition or by a small variation of the enthalpy of fusion of the polyester polyol. These measures require only exploratory tests and are completely within the practical experience of a person of average skill in the art in this field.

The production of polyester polyols b) is known from the prior art.

The number-average molecular weight of the polyester polyols b) is preferably 400 to 4000 g/mol, further preferably 1000 to 3000 g/mol, more preferably 1500 to 2500 g/mol, most preferably 1800 to 2400 g/mol.

The melting temperature of the crystalline or semicrystalline polyester polyols is generally at least 35° C., preferably 40 to 80° C., more preferably 42 to 60° C. The enthalpy of fusion is ≥15 J/g, preferably ≥40 J/g, and more preferably 50 J/g.

Further details of the preparation of a polyurethane containing carboxyl groups can be found in patent specification EP3502157A1 and EP2186841A1 and EP3795601A1.

The polyurethane polymers suitable as component (B) may be present and used in solid or solution form or as a dispersion in a liquid medium. The polyurethane polymers are preferably provided as aqueous dispersions. Such polyurethane dispersions suitable as component (A) preferably include nonvolatile fractions of 15% by weight to 70% by weight, preferably of 20% by weight to 60% by weight, based on the total weight of the polyurethane dispersions. The pH is preferably in the range from 4 to 11, more preferably 5 to 8. Average particle sizes ascertained by laser diffraction are typically in the range from 20 nm to 750 nm, preferably in the range from 30 nm to 450 nm.

Polyurethane dispersions suitable as component (B) are preferably anionically stabilized polyurethane dispersions. One example of a commercially available polyurethane dispersion suitable as component (B) is Dispercoll® U 2824 from Covestro Deutschland AG.

The at least one polymer suitable as component (A) and the at least one polyurethane polymer suitable as component (B) are preferably present in such a mixing ratio that the dried adhesive film has the following proportions: at least 30% by weight, preferably at least 40% by weight, more preferably at least 40% by weight to 89% by weight of the at least one polymer suitable as component (A), based on the total weight of components (A) and (B) as 100% by weight.

In a preferred embodiment, the average molecular weight (Mw) of polymer (A)≥the average molecular weight (Mw) of polyurethane polymer (B), preferably wherein the average molecular weight (Mw) of polymer (A) is greater than the average molecular weight (Mw) of polyurethane polymer (B), in each case determined to DIN EN ISO 13885-2 (2021-11) with N,N-dimethylacetamide as eluent and polystyrene as standard.

In a preferred embodiment, the at least one polyurethane polymer (B) has an average molecular weight (Mw) in the range from 20 000 g/mol to 300 000 g/mol, preferably in the range from 20 000 g/mol to 200 000 g/mol, more preferably in the range from 20 000 g/mol to 100 000 g/mol, even more preferably in the range from 40 000 g/mol to 80 000 g/mol, in each case determined in accordance with DIN EN ISO 13885-2 (2021-11) with N,N-dimethylacetamide as eluent and polystyrene as standard.

In a preferred embodiment, the polyurethane polymer (B) has a partial acid number in the range from 2.5 mg KOH/g to 25 mg KOH/g, preferably in the range from 2.5 mg KOH/g to 12.5 mg KOH/g, in each case determined in accordance with DIN EN ISO 2114:2000 (2002-06, Method A with an acetone-ethanol solvent mixture).

In a preferred embodiment, the proportion of component (B) in the aqueous adhesive formulation, based on total proportions of components (A), (B), (C) and (D) as 100% by weight, is 10% by weight to 70% by weight, preferably 17% by weight to 70% by weight, of component (B).

### Component (C)

The aqueous adhesive formulation according to the invention and the kit-of-parts according to the invention contain, as component (C), at least one polycarbodiimide and/or at least one polyaziridine and/or a mixture thereof.

In a preferred embodiment, the aqueous adhesive formulation according to the invention and the kit-of-parts according to the invention contain at least one polycarbodiimide as component (C).

The term “carbodiimide group” or “carbodiimide structural unit” corresponds to the chemical structure —N═C═N—.

According to the invention, polycarbodiimide means compounds containing more than one carbodiimide structural unit.

Suitable polycarbodiimides preferably have the structure of the formula I as part of the molecular structure:

[symbol]

N═C═N—R [symbol] ₙ Formula (I)

in which n is an integer of 2 or more, preferably 2 to 50, most preferably 3 to 6; and R is preferably one or more of the following groups: an aliphatic organic group, an alicyclic organic group and an aromatic organic group containing carbon and hydrogen atoms.

Suitable polycarbodiimides can be prepared by commonly known methods, for example by decarboxylating condensation of diisocyanates, for example of aromatic diisocyanates, aliphatic diisocyanates and alicyclic diisocyanates. Preference is given to using one or more of the following diisocyanates: naphthalene 1,5-diisocyanate, diphenylmethane 4,4′-diisocyanate, diphenyldimethylmethane 4,4′-diisocyanate, phenylene 1,3-diisocyanate, phenylene 1,4-diisocyanate, tolylene 2,4-diisocyanate, tolylene 2,6-diisocyanate, hexamethylene diisocyanate, cyclohexane 1,4-diisocyanate, xylylene diisocyanate, isophorone diisocyanate, dicyclohexylmethane 4,4′-diisocyanate, methylcyclohexane diisocyanate, tetramethylxylylene diisocyanate, 3,3′,5,5′-tetraisopropyldiphenyl 4,4′-diisocyanate and 1,3,5-triisopropylbenzene 2,4-diisocyanate, optionally also with additional use of monofunctional isocyanates, for example stearyl isocyanate, phenyl isocyanate, butyl isocyanate, hexyl isocyanate or/and higher-functionality isocyanates such as trimers, uretdiones, allophanates, biurets of the diisocyanates mentioned by way of example, and subsequent, simultaneous or else prior reaction with hydrophilizing components, for example mono- or difunctional polyethers based on alcohol- or amine-started ethylene oxide polymers or ethylene oxide/propylene oxide copolymers.

Polycarbodiimides having carbodiimide groups that have been prepared from aliphatic, araliphatic and/or cycloaliphatic isocyanate groups are preferred; polycarbodiimides having carbodiimide groups that have been prepared from aliphatic and/or cycloaliphatic isocyanate groups are particularly preferred.

Particularly preferred carbodiimides are obtained by decarboxylating condensation of 1-isocyanato-3,3,5-trimethyl-5-isocyanatomethylcyclohexane and/or 4,4′-diisocyanatodicyclohexylmethane.

For example, a suitable polycarbodiimide is prepared by a decarboxylating condensation proceeding from one or more above-described diisocyanates with use of an organic phosphorus compound or an organometallic compound as catalyst in the absence of a solvent or in an inert solvent at a temperature of about 70° C.

The preparation is preferably effected by heating at least one diisocyanate in the presence of a suitable catalyst, for example phospholine oxide, to 100 to 250° C. with elimination of carbon dioxide until the desired degree of conversion has been attained. The progression of the reaction can be followed, for example, via the decrease in concentration of isocyanate groups in the reaction mixture. The reaction mixture containing isocyanate groups which is thus obtained is then reacted with at least one hydroxy-functional polyether based on ethylene oxide or based on ethylene oxide and propylene oxide, optionally with simultaneous or subsequent reaction with further hydroxy- and/or amino-functional and/or other isocyanate-reactive compounds, for example butylglycol, and optionally followed by dispersion, emulsification or dissolution.

The prior art that describes the preparation and stabilization of polycarbodiimides can be found in European patent applications EP 3 502 157 A1 and EP 2 552 982 A2.

Suitable polycarbodiimides are, for example, Carbodilite® SV-02, Carbodilite® V-02-L2 and Carbodilite® E-02 (all from Nisshinbo Industries, Tokyo, Japan), and Desmodur® 2802 from Covestro Deutschland AG. Preferred polycarbodiimides are Desmodur® 2802 and Carbodilite® V-02-L2; Desmodur® 2802 is particularly preferred.

Suitable polyaziridines to be used in accordance with the invention are the compounds known to the person skilled in the art that contain more than one aziridine group reactive with carboxyl groups. Examples of commercially available polyaziridines are PZ-28 and PZ-33 from Polyaziridine, LLC. Medford, N.J., USA, HD-105 from Shanghai Holdenchem CO, Ltd, Shanghai, China, and NeoAdd Pax® 521, NeoAdd Pax® 524., NeoAdd Pax® 523, NeoAdd Pax® 521 and Crosslinker CX-100 from Covestro. and Xama 7 from ichemco Co, Italy. Particular preference is given to using Crosslinker CX-100 from Covestro (reaction mixture composed of 2-ethyl-2-[[3-(2-methylaziridin-1-yl)propionyl]methyl]propane-1,3-diyl bis(2-methylaziridine-1-propionate) and 2,2-bis({[3-(2-methylaziridin-1-yl)propanoyl]oxy}methyl)butyl 3-[2,2-bis({[3-(2-methylaziridin-1-yl)propanoyl]oxy}methyl)butoxy]propanoate), NeoAdd Pax® 521 and NeoAdd Pax® 523. Even more preferably, NeoAdd Pax®521 and NeoAdd Pax® 523 are used.

The polycarbodiimide and/or the polyaziridine may take the form of and be used as a dispersion, solution, solid or liquid; it is preferably used in the form of an aqueous dispersion.

In a preferred embodiment, component (C) is at least one polycarbodiimide. In a further preferred embodiment, component (C) is at least one hydrophilically modified, dispersible, dispersed or solvent-dissolved polycarbodiimide, component (C) is preferably at least one hydrophilically modified or dispersible or dispersed polycarbodiimide, and component (C) is more preferably at least one hydrophilically modified polycarbodiimide. In a further preferred embodiment, component (C) has an average molecular weight (Mw) in the range from 500 g/mol to 50 000 g/mol, more preferably in the range from 1000 g/mol to 20 000 g/mol, even more preferably in the range from 2000 g/mol to 5000 g/mol, determined in accordance with DIN EN ISO 13885-2 (2021-11) with N,N-dimethylacetamide as eluent and polystyrene as standard.

In a preferred embodiment, the at least one component C) is a polycarbodiimide and has a glass transition temperature of in the range from −100° C. to 50° C., preferably in the range from −60° C. to 35° C., more preferably in the range from −60° C. to 30° C., even more preferably in the range from −50° C. to 29° C., determined by DSC (differential scanning calorimetry) DIN EN ISO 11357-1 (2017-02).

In a preferred embodiment, the at least one polycarbodiimide has a content of carbodiimide groups (—N═C═N—) in the range from 0.5 mmol/g to 5 mmol/g, determined by ATR infrared spectroscopy against a dicyclocarbodiimide standard, based on the total weight of the at least one polycarbodiimide. In a preferred embodiment, the molar ratio of carbodiimide groups (—N═C═N—) in component C) to the carboxyl groups (—COOH) in component B) is in the range from 0.2:1 to 5:1, preferably in the range from 0.5 to 2.9:1.

In a preferred embodiment, the proportion of component (C) in the aqueous adhesive formulation, based on total proportions of components (A), (B), (C) and (D) as 100% by weight, is 1% by weight to 30% by weight, preferably 3% by weight to 20% by weight, of component (C).

### Component (D)

The aqueous adhesive formulation according to the invention and the kit-of-parts according to the invention may optionally contain, as component (D), at least one further polymer different than the at least one polymer (A) and the at least one polyurethane polymer (B).

Suitable components (D) are, for example, polyvinylester, polyvinylether, polyvinylalcohol, polyethylene, polystyrene, polybutadiene, polyvinylchloride, polyurethane, polyurethane-polyurea, polyurethane-polyacrylate, polyester, polyacrylate and/or copolymers thereof. The polymers suitable as component (D) may be present and used in solid or solution form or as a dispersion in a liquid medium. Preferably as dispersions or emulsions or aqueous or organic solution. Dispersions containing component (D) may also be used collectively in a mixture together with other aqueous or solvent-containing oligomers or polymers. In the case of such mixtures, compatibility must be checked in each case by simple preliminary tests.

In a preferred embodiment, the proportion of component (D) in the aqueous adhesive formulation, based on total proportions of components (A), (B), (C) and (D) as 100% by weight, is 0% by weight to 30% by weight, preferably 0% by weight to 25% by weight, of component (D).

In a preferred embodiment, the at least one polymer (D) has a partial acid number in the range from 0 mg KOH/g to 1 mg KOH/g, preferably in the range from 0 mg KOH/g to 0.05 mg KOH/g, in each case determined in accordance with DIN EN ISO 2114:2000 (2002-06, Method A with an acetone-ethanol solvent mixture).

In a preferred embodiment, the at least one polymer (D) does not have any carboxyl groups and/or carboxylate groups. In a preferred embodiment, the at least one polymer (D) does not have any sulfone groups and/or sulfonate groups.

In a preferred embodiment, the aqueous adhesive formulation according to the invention and the kit-of-parts according to the invention may optionally contain at least one additive other than components (A), (B), (C) and (D).

An additive means all binders, auxiliaries and aggregates known from coatings and adhesives technology, especially emulsifiers and light stabilizers such as UV absorbers and sterically hindered amines (HALS), also antioxidants, fillers and auxiliaries, e.g. antisettling agents, defoaming and/or wetting agents, levelling aids, reactive diluents, plasticizers, neutralizing agents, catalysts, auxiliary solvents and/or thickeners and additives such as pigments, dyes or flatting agents for example. Tackifiers may also be added as additive. The additives are different from components (A), (B), (C) and (D).

The additives can be added directly to the products according to the invention prior to processing. They may be added alone or together with components (A), (B), (C) and (D). Components (A), (B), (C) and (D) are preferably added as dispersions in an aqueous medium. It is alternatively possible to add at least a portion of the additives before or during the dispersing of the binder.

The selection and the metered addition of these substances, which can be added to the individual components and/or to the whole mixture, are known in principle to those skilled in the art and may be determined without unduly high effort, tailored to the specific application, by simple preliminary experiments.

The aqueous adhesive formulations according to the invention are preferably produced by mixing the components with one another.

The present invention therefore also relates to a process for producing the aqueous adhesive formulation according to the invention by mixing the individual components.

The production of the aqueous adhesive formulation according to the invention preferably comprises at least the following steps:
i) providing components (A), (B), (C), optionally (D), optionally at least one additive and optionally an aqueous medium, where components (A), (B), (C) and optionally (D) may each independently be in the form of an aqueous dispersion, and
ii) mixing the components provided in step i) and the optional at least one additive, and optionally dispersing in an aqueous medium, in order to obtain an aqueous adhesive formulation in the form of an aqueous dispersion.

In a further preferred embodiment, the production of the aqueous adhesive formulation according to the invention comprises at least the following steps:
i) providing components (A), (B), (C) and optionally (D);
ii) dispersing components (A), (B), (C) and optionally (D) in an aqueous medium in order to obtain at least one aqueous dispersion; and
iii) optionally mixing the at least one aqueous dispersion from step ii) with at least one additive other than components (A), (B), (C) and (D) in order to obtain an aqueous adhesive formulation;
or
i′) providing at least a first aqueous dispersion containing component (A);
ii′) providing at least a second aqueous dispersion containing component (B);
iii′) providing at least a third aqueous dispersion containing component (C);
iv′) optionally providing at least a fourth aqueous dispersion containing component (D); v′) mixing the aqueous dispersions from steps i′)-v′) in any sequence and optionally at least one additive other than components (A), (B), (C) and (D) in order to obtain an aqueous adhesive formulation.

The process according to the invention for producing the aqueous adhesive formulation according to the invention, and also the production of the individual solutions or dispersions used, can generally be effected under all conditions that seem suitable to those skilled in the art, for example at a temperature of 18 to 28° C., ideally at room temperature (23° C.), further preferably in apparatus known to those skilled in the art, for example in stainless steel, glass or enamelled process apparatus. In the course of production of the aqueous adhesive formulation according to the invention, the formation of rust and soluble metal alloys, including from aluminium containers, must be avoided.

The present invention additionally also relates to the method of the invention for establishing an adhesive bond on substrates, wherein an adhesive formulation according to the invention is applied to at least one substrate, then dried, and optionally heated to a temperature in the range from 40° C. to 200° C., preferably 50° C. to 120° C., more preferably 55° C. to 100° C., followed by bonding.

In a further preferred embodiment, the method according to the invention for establishment of an adhesive bond on substrates comprises the following steps:
i) providing at least one substrate;
ii) applying the aqueous adhesive formulation according to the invention on at least part of at least one surface of the at least one substrate from step i);
iii) drying the at least one surface of the at least one substrate from step ii) to which the aqueous adhesive formulation has been applied;
iv) heating the at least one substrate surface treated in step iii) by IR radiation, or another suitable supply of heat, with heating of the at least one substrate surface preferably to a temperature in the range from 40° C. to 200° C., preferably 50° C. to 120° C., more preferably 55° C. to 100° C.; and
v) contacting the heated at least one substrate surface from step iv) with a further untreated portion of the surface of the at least one substrate or with at least a portion of a surface of another substrate in order to obtain an adhesive bond;
or
i′) providing at least one substrate;
ii′) applying the aqueous adhesive formulation according to the invention on at least part of at least one surface of the at least one substrate from step i′);
iii′) drying the at least one surface of the at least one substrate from step ii′) to which the aqueous adhesive formulation has been applied; and
iv′) contacting the at least one substrate surface from step iii′) with at least a portion of at least one surface of at least one further heated substrate in order to obtain an adhesive bond, where the at least one further substrate is preferably heated to a temperature in the range from 40° C. to 200° C., preferably 50° C. to 120° C., more preferably 55° C. to 100° C.;
or
i″) providing at least two substrates;
ii″) applying the aqueous adhesive formulation according to the invention on at least part of at least one surface of each of the at least two substrates from step i″);
iii″) drying the at least one surface of each of the at least two substrates from step ii″) to each of which the aqueous adhesive formulation has been applied;
iv″) heating the at least two substrate surfaces each treated in step iii″) by IR radiation, or another suitable supply of heat, with heating of the at least two substrate surfaces preferably to a temperature in the range from 40° C. to 200° C., preferably 50° C. to 120° C., more preferably 55° C. to 100° C.; and
v″) contacting the at least one heat-activated substrate surface from step iv″) with the at least one other heat-activated substrate surface from step iv″) in order to obtain an adhesive bond.

In a further preferred embodiment, the method according to the invention for establishment of an adhesive bond on substrates comprises the following steps:
i. applying the adhesive according to the invention to at least one surface of a substrate;
ii. heating and drying the substrate surface to which the adhesive is applied;
iii. thermally activating the substrate surface treated in step ii by IR radiation, or another suitable supply of heat; and
iv. contacting the substrate surface treated in step iii with a surface of the substrate itself or an additional substrate in order to obtain the bonded product.

The substrate is preferably embodied by one or more of the following: wood, plastic, metals and alloys, particleboards, MDF boards, ceramic, stone, concrete, bitumen, hard fibreboard, glass, glass fibres, carbon fibres, carbon nanotubes, porcelain, leather, textiles and/or a wide variety of different textile fibres, woven fabric, imitation leather, paper, paperboard, EVA, rubber, leather hide, ethylene-vinyl acetate copolymer, polyolefin, thermoplastic polyurethane, polyurethane foam, polymer fibres and graphite fibres.

The substrates may be pretreated in order to improve adhesion of the adhesive film on the substrate. Useful pretreatments are, for example, corona, plasma, flame, chemical priming, and combinations thereof.

The aqueous adhesive formulation according to the invention is likewise suitable for bonding rubber materials, for example natural and synthetic rubbers, various plastics such as polyurethanes, polyvinylacetate, polyvinylchloride, especially plasticizer-containing polyvinylchloride. The adhesives are likewise suitable for the bonding of thermoplastics, for example ABS (acrylic-butadiene-styrene), PC (polycarbonate) and mixtures thereof, and polyolefinic plastics, optionally after suitable pretreatment.

The aqueous adhesive formulation according to the invention is processed by the known methods of coating technology or adhesive technology with regard to the uses and processing of aqueous dispersions or aqueous emulsions or aqueous solutions.

The “applying” may mean that the adhesive is applied to the whole surface area of the substrate or only to one or more portions of the substrate surface.

The “applying” can be effected by painting, dipping, spraying, rolling, knife coating, flow coating, casting, printing or transfer printing, preferably by painting, dipping or spraying.

The “heating and drying of the substrate surface to which the adhesive is applied” may relate solely to the heating and drying of the substrate surface or to the heating and drying of a portion of or the whole substrate including the substrate surface to which the adhesive is applied.

The “heating and drying” can remove a volatile constituent. The volatile component may be water.

The “heating and drying” is preferably effected by one or more of the following measures: infrared thermal radiation, near-infrared thermal radiation, microwaves and the use of a convection oven at elevated temperature.

The heating temperature is as high as possible but should not be above the temperature limit at which the substrate is subject to uncontrolled deformation or other damage.

When the aqueous adhesive formulation according to the invention is used, for example, for adhesives for bonding of substrates, this is commonly done by the heat-activation method. The adhesive layer is activated here and converted to an adhesive state by heating, for example with an infrared source. The temperature at which the adhesive film becomes tacky is referred to as the activation temperature.

The “contacting” is preferably effected before the temperature of the substrate surface is lower than the temperature at which the adhesive is sticky, and preferably before the temperature of the substrate surface is below 55° C.

The substrate surface treated in step iv is preferably contacted with the substrate itself or an additional substrate within one hour, further preferably within 30 minutes, more preferably within 10 minutes and most preferably within 5 minutes, in order to obtain the bound product.

The additional substrate may be any substrate that has to be bonded.

The additional substrate may be identical to or different from the substrate.

Like the substrate, the additional substrate is also preferably coated, heated and activated with heat.

After the substrate surface treated in step ii or treated in step iv has been contacted with the substrate itself or the additional substrate, it is possible to conduct a further cooling treatment in order to lower the temperature of the bonded product to room temperature.

The method of heat supply is preferably one or more of the following: use of a convection oven or infrared thermal radiation, near-infrared thermal radiation, microwaves, and heat transfer by an article that comes into contact with the substrate coated with the adhesive of the invention.

The present invention further provides for the use of the aqueous adhesive formulation according to the invention for production of latently reactive adhesive layers, self-supporting latently reactive adhesive films and latently reactive adhesive powders.

The present invention further provides for the use of latently reactive adhesive layers, self-supporting latently reactive adhesive films and latently reactive adhesive powders, each comprising the aqueous adhesive formulation according to the invention for bonding or binding of substrates.

The aqueous adhesive formulation in the form of an aqueous dispersion may also be applied to release paper (e.g. silicone paper or polyolefinic nonstick paper or similar carrier materials) by spray, knife, brush or roller application methods. Drying affords self-supporting, latently reactive films or nonwoven webs that, optionally after inserting a release paper, can be rolled up and stored as an adhesive film until use.

It is possible to obtain a latently reactive adhesive powder in the form of granules or a powder from the aqueous adhesive formulation in the form of an aqueous dispersion by suitable technical methods.

For example, the aqueous adhesive formulation in the form of an aqueous dispersion may be freed of water by spray drying. What is thus obtained is a latently reactive adhesive powder that may optionally be ground to small particle sizes by a subsequent grinding process.

Another way of producing latently reactive powders is to freeze out at least a portion of the constituents present in the aqueous adhesive formulation in the form of an aqueous dispersion at temperatures below 0° C. This affords solids that are then largely freed of water by filtration, centrifugation etc. and finally dried. The coarse-grain powder obtained can then be brought to the required particle sizes by suitable grinding, for example in bead mills, ball mills, sand mills or jet mills.

The present invention further provides for the use of the kit-of-parts according to the invention for production of latently reactive adhesive layers, self-supporting latently reactive adhesive films and latently reactive adhesive powders.

The present invention further provides for the use of the aqueous adhesive formulation according to the invention for bonding of wood, paper, thermoplastics, elastomeric plastics, thermoplastic-elastomeric plastics, vulcanizates, textile fabrics, knitted fabrics, braids, leather, metals, ceramics, asbestos cement, stoneware, concrete, foams, in each case with one another and/or on porous substrates, preferably having a density of less than 1 kg/litre, especially for the bonding of foams in the manufacture of mattresses, furniture and/or upholstery.

The present invention further provides an article produced using the aqueous adhesive formulation according to the invention, wherein the article is preferably a moulded article laminated to thermoplastic film, preferably a moulded article made of plastic, wood or a woodbase material, for example MDF.

In a further preferred embodiment, the article is a footwear item or an item of furniture. In addition, it is also possible to use the aqueous adhesive formulation according to the invention that has been developed here in further applications, for example in the bonding of automobile interior parts.

### EXAMPLES

The present invention is elucidated further by the examples that follow, without being restricted thereto.

### Raw Materials and Reagents

Polyester I: Polyester diol formed from butane-1,4-diol and adipic acid, OH value 50
Polyester II: Polyester diol formed from hexane-1,6-diol, neopentyl glycol, and adipic acid, OH value 56
Polyester III: Polyester diol formed from hexane-1,6-diol and adipic acid, OH value 50
Desmodur® H: Hexamethylene 1,6-diisocyanate (Covestro Deutschland AG, Leverkusen/Germany)
Desmodur® I: Isophorone diisocyanate (Covestro Deutschland AG, Leverkusen/Germany)
Lucramul® 1820 liq: Emulsifier, 15% by weight solution of stearyl alcohol polyglycol ether in water (Levaco Chemicals GmbH, Leverkusen)

### Desmodur® 2802

Desmodur® 2802 is a hydrophilically modified polycarbodiimide having a nonvolatile fraction of 40% by weight, a carbodiimide group content of about 1.4 meq DCC/g, a weight-average molecular weight Mw of 3258 g/mol and an average carbodiimide group functionality of 4.5, sourced from Covestro AG. A carbodiimide concentration of 3.5 meq DCC for the dried polycarbodiimide is calculated from the nonvolatile fraction and the carbodiimide group content. The glass transition temperature is −30° C.

### NeoAdd® PAX-521

NeoAdd® PAX-521 (Covestro Deutschland AG, Leverkusen, Germany) is a polymeric polyaziridine having a solids content of 80% in ethyl acetate.

### Picassian® XL-721

Picassian® XL-721 is a polycarbodiimide having a nonvolatile fraction of 49% in propylene glycol diacetate (PGDA), a carbodiimide group content of about 1.15 meq DCC/g, a weight-average molecular weight Mw of 2643 g/mol from Stahl Holdings B.V. A carbodiimide concentration of 2.3 meq DCC for the dried polycarbodiimide is calculated from the nonvolatile fraction and the carbodiimide group content. The glass transition temperature is −38° C.

### Picassian® XL-725

Picassian® XL-725 is a polycarbodiimide having a nonvolatile fraction of 100%, a carbodiimide group content of about 1.47 meq DCC/g, a weight-average molecular weight Mw of 3356 g/mol from Stahl Holdings B.V. The glass transition temperature is −67° C.

### Dispercoll® U2824

Dispercoll® U 2824 (Covestro Deutschland AG, Leverkusen, Germany) is a carboxylate-stabilized polyester polyurethane dispersion containing dimethylpropionic acid as formation component (nonvolatile fraction in the dispersion 40%). The polymer present is semicrystalline in the DSC analysis. The polyurethane dispersion has a partial acid number of 4.0 mg KOH/g. The partial acid number of the dried polymer is 10 mg KOH/g. The dried dispersion polymer has an enthalpy of fusion of 51 J/g and a melting temperature of about 47° C. The average molecular weight Mw is 65 000 g/mol.

### Dispercoll® UXP2643

Dispercoll® U XP 2643 (Covestro Deutschland AG, Leverkusen, Germany) is a carboxylate-stabilized polyurethane dispersion based on a polyether and dimethylpropionic acid (nonvolatile fraction of the dispersion 40%). The dried polymer does not have a melting peak in the DSC analysis; its glass transition temperature is −51° C. The product has an acid number of 4.0 mg KOH/g. The partial acid number of the dried polymer is 10 mg KOH/g. The average molecular weight Mw is 64 000 g/mol.

### Dispercoll® U42

Dispercoll® U 42 (Covestro Deutschland AG, Leverkusen, Germany) is a sulfonate-stabilized polyurethane dispersion based on a polyester (solids content of the dispersion 50%). The dried polymer does not have a melting peak in the DSC analysis; its glass transition temperature is −5° C. The partial acid number is 0 mg KOH/g. The average molecular weight Mw is 219 000 g/mol.

### Uradil® FP 9300

Uradil FP 9300 (Covestro Deutschland AG, Leverkusen, Germany) is a colloidal dispersion of an aromatic polyester without surfactant in water (solids content of the dispersion 30%). The dried polymer does not have a melting peak in the DSC analysis; its glass transition temperature is 48° C. The partial acid number is <1.0 mg KOH/g. The average molecular weight Mw is 25 000 g/mol.

### Production of Aqueous Polyurethane Dispersions

### Polyurethane Dispersion PUD-A-1

578 g of polyester III was dewatered at 110° C. and 15 mbar for 1 hour. At 60° C., 9.9 g of butane-1,4-diol was first added while stirring. Then 40.7 g of Desmodur® I and 62.1 g of Desmodur® H were added at 80° C., and the mixture was stirred at 100° C. until a constant isocyanate content of 2.2% had been attained. The reaction mixture was dissolved in 1038 g of acetone, which cooled it to 48° C. A solution of 21.8 g of the sodium salt of N-(2-aminoethyl)-2-aminoethanesulfonic acid and 4.7 g of ethylenediamine in 36.6 g of water was added to the homogeneous solution with vigorous stirring. After 30 minutes, dispersion was effected by addition of 976 g of water. Distillative removal of the acetone afforded an aqueous polyurethane-polyurea dispersion having a nonvolatile fraction of 40%. The dried dispersion polymer has an enthalpy of fusion of about 56 J/g and a melting temperature of about 51° C., and a glass transition temperature of −54° C. The average molecular weight Mw is 330 000 g/mol. The partial acid number of the dried polymer is 0.9 mg KOH/g.

### Polyurethane Dispersion PUD-A-2

450 g of polyester I and 42.67 g of polyester II were dewatered at 110° C. and 15 mbar A for 1 hour. At 60° C., first 2.24 g of butane-1,4-diol and then a mixture of 38.02 g of Desmodur® H and 25.11 g of Desmodur® I were added while stirring. The mixture was heated to 80° C. and stirred until a constant isocyanate content of 1.30% by weight had been attained. The reaction mixture was dissolved in 770 g of acetone and cooled to 48° C. A solution of 6.56 g of the sodium salt of N-(2-aminoethyl)-2-aminoethanesulfonic acid and 5.16 g of diethanolamine in 100 g of water was added to the homogeneous solution with vigorous stirring. After 30 minutes, the mixture was dispersed by addition of 470 g of water. Distillative removal of the acetone afforded an aqueous polyurethane-polyurea dispersion having a nonvolatile fraction of 50%. The polymer present is semicrystalline after drying with a melting temperature of 49° C. and an enthalpy of fusion of 57.0 J/g, and a glass transition temperature of −57° C. The average molecular weight is 97 000 g/mol. The partial acid number is 0 mg KOH/g.

### Production of the Adhesive

The constituents of the aqueous adhesive dispersions that are specified in Table 1 are weighed successively into a plastic beaker with a screwtop lid. Mixing is effected at 1000 revolutions per minute for 3 minutes in a Speedmixer®.

What are obtained are low-viscosity aqueous adhesive formulations which, even after storage under standard conditions for several weeks, show no signs of a rise in viscosity or sedimentation.

### Test Methods

Unless stated otherwise, all analytical determinations and test methods are based on a temperature of 23° C.

### Determination of Partial Acid Number

Partial acid number is determined in accordance with DIN EN ISO 2114:2000 (2002-06, Method A), except using, rather than the solvent mixture of 2 parts by volume of toluene (5.7) and 1 part by volume of ethanol (5.5) which is specified in 5.1, a solvent mixture of 2 parts by volume of acetone (5.4) and 1 part by volume of ethanol (5.5).

The acid number of the polymer dispersions was determined by using them directly, unless stated otherwise. The amounts of sample used were guided by the specifications in 7.1.

The partial acid number of the dried polymer corresponds to the partial acid number of the solid resin as described in 8.1.2, and is calculated analogously.

### Determination of Nonvolatile Fractions

The nonvolatile fractions of the polymer dispersions were determined in accordance with DIN EN ISO 3251, starting weight: 1 g, drying at 125° C. for 1 h.

### Determination of Glass Transition Temperatures, Melting Temperatures and Enthalpies of Fusion by Differential Scanning Calorimetry (DSC)

Glass transition temperatures, melting temperatures and enthalpies of fusion were determined by differential scanning calorimetry (DSC) using a TA Instruments DSC Q2000 calorimeter.

The determination is effected in accordance with DIN EN ISO 11357-1:2017 (2017-02)—Plastics—Differential Scanning Calorimetry (DSC)—Part 1: General Principles (ISO 11357-1:2016); German version EN ISO 11357-1:2016

and the following parts of the standard:
DIN EN ISO 11357-2:2020-08—Plastics—Differential scanning calorimetry (DSC)—Part 2: Determination of glass transition temperature and step height (ISO 11357-2:2020); German version EN ISO 11357-2:2020
DIN EN ISO 11357-3:2018-07—Plastics—Differential scanning calorimetry (DSC)—Part 3: Determination of temperature and enthalpy of melting and crystallization (ISO 11357-3:2018).

### Sample Preparation for Aqueous Dispersions

For this purpose, a film was produced by knife-coating the dispersion with wet film thickness 100 μm on a glass plate, predrying at 23° C. and 50% relative humidity for 2 hours, then transferring the coated glass plate into a dry box and storing it there at 23° C. and 0% relative humidity for 3 days.

The coated glass plate is removed from the dry box, and about 5 mg of sample material is used for the DSC analysis.

The following analysis program is conducted:

Rapid cooling to the starting temperature of −100° C., followed by commencement of three heating runs from −100° C. to +150° C. at a heating rate of 20 K/min and a cooling rate of 320 K/min under a nitrogen atmosphere and with cooling with liquid nitrogen.

### Determination of Glass Transition Temperatures

Glass transition temperatures (Tg) were ascertained according to the specifications of DIN EN ISO 11357-2:2020-08

The glass transition temperature corresponds to the temperature at half height of the glass transition, it being the third heating that was evaluated. If it should not be possible to ascertain a glass transition temperature, the analysis program is altered as follows: Rapid cooling to the starting temperature of −140° C., followed by commencement of three heating runs from −140° C. to +150° C. at a heating rate of 20 K/min and a cooling rate of 320 K/min.

### Determination of Melting Temperatures

Melting temperatures are determined from the first heating run; the melting temperatures reported correspond to the peak crystallization temperatures.

### Determination of Enthalpies of Fusion

Enthalpies of fusion are determined from the first heating run. In the case of multiple melt peaks, the enthalpies of fusion of all melt peaks having a peak melting temperature Tp,m in the range from 15 to 80° C. are added up. Peaks having enthalpies of fusion of <0.9 J/g are not considered.

### Determination of Molecular Weight

Molecular weight Mn, Mw, Mz is determined in accordance with DIN EN ISO 13885-2:2021-11 with N,N-dimethylacetamide as eluent against a polystyrene standard.

### Calculation of the Molar Ratio of Carbodiimide Groups (—N═C═N—) in Component C) to the Carboxyl Groups (—COOH) in Component (B)

The molar ratio of carbodiimide groups (—N═C═N—) in component C) to the carboxyl groups (—COOH) in component (B), CDI/COOH, is calculated from the molar amount of carbodiimide groups nCDI [meq DCC] in component (C) and the molar amount of carboxyl groups nCOOH [mmol/g] in component (B).

The molar amount of COOH groups nCOOH in component (B) is calculated by the following formula:

nCOOH=partial acid number [mg KOH/g]×mass [g]/56.1[mmol/mg KOH]

If component (B) should consist of two or more polymers, it is thus possible to calculate the molar amount for each polymer and to add up the individual molar amounts.

### Determination of the Carbodiimide Concentration in Component C

Carbodiimide concentration is determined by ATR infrared spectroscopy using the Perkin Elmer Spectrum two instrument. (ATR is an abbreviation for “attenuated total reflection”.

First of all, dicyclohexylcarbodiimide (DCC) is dissolved in ethanol (concentrations: 0.1 mmol/g, 0.2 mmol/g, 0.5 mmol/g, 1.0 mmol/g, 1.5 mmol/g, and 2 mmol/g). The IR spectra of these solutions were recorded. The peak areas (PA) of the carbodiimide band at about 2118 cm⁻¹ are determined.

The data (concentration c of the DCC solutions and the PA ascertained) are used to generate a calibration line:

PA=m·c [meq DCC/g], where m is the slope of the calibration line.

If the polycarbodiimides to be used in component C) are in the form of an aqueous dispersion, the aqueous dispersion is analysed directly in ATR infrared spectroscopy. The carbodiimide concentration is determined from PA of the band at about 2118 cm⁻¹. The carbodiimide concentration c of the aqueous dispersion [meq DCC/g] is calculated by the formula PA/m. Taking account of the nonvolatile fraction of the dispersion, this can be used to calculate the carbodiimide concentration c) of the polycarbodiimide. The carbodiimide concentration of component C) and the mass of component C), Mc, are used to determine the molar amount of carbodiimide groups nCDI [meq DCC].

nCDI [meq DCC]=Mc [g]×c [meg DCC/g]

In the case of carbodiimides in solid form, the carbodiimide concentration is determined as described in WO2020216680A1 using a 25% solution in toluene and converted to solids. The ratio of carbodiimide groups in component (C) to the carboxylic acid groups in component (B) for Example 7 in Table 1 is calculated as follows:

nCOOH=10 [mg KOH/g]×40%×50 g/56.1 [mmol/mg KOH]=3.57 mmol

nCDI [meq DCC]=7.1 [g]×40%×3.5 [meq DCC/g]=9.94 [meq DCC]

The ratio of carbodiimide groups in component (C) to the carboxylic acid groups in component (B) for Example 7 is calculated as 9.94 to 3.57, i.e. 2.8:1.

### Determination of Heat Resistance Via a Softening Point Measurement (Lap Shear Stress)

Softening point values were determined from a canvas-canvas composite combination.

The adhesive dispersions are applied with a brush to the cotton test specimens (25 mm×50 mm), so as to result in bonding areas of size 20 mm×10 mm.

The adhesive layer is dried at 23° C./50% relative humidity for 30 min. Then a second adhesive layer is applied by brush. Then the adhesive layer is dried at 23° C./50% relative humidity for a further 60 min. The adhesive-coated test specimens are heat-activated with a Funck IR source (2000 shock activation device) for 10 seconds. This increases the surface temperature of the adhesive layer to 90° C. The adhesive bond is established immediately after the thermal activation by pressing the activated adhesive layers together in a press at 4 bar for 1 min. The test specimens thus produced are stored under standard climatic conditions (23° C./50% relative humidity) for 1 week.

After the storage period, the test specimens are subjected to a load of 4 kg (lap shear stress) and heated to 40° C. in a heating cabinet within 30 min. Subsequently, the test specimens are heated up to 150° C. at a linear heating rate of 0.5 K/min. The softening point, i.e. the temperature in ° C. at which the adhesive bond fails under a load of 4 kg, is registered. 5 individual measurements are conducted in each case, and the average is determined and reported.

Determination of Heat Resistance after Storage Via a Softening Point Measurement (=Lap Shear Stress) for Determination of the Open Time of the Dried Adhesive Layer

Softening point values are determined from a canvas-canvas composite combination.

The adhesive dispersions are applied with a brush to the cotton test specimens (25 mm×50 mm), so as to result in bonding areas of size 20 mm×10 mm. The adhesive layer is dried at 23° C./50% relative humidity for 30 min. Then a second adhesive layer is applied by brush. The adhesive layer is dried at 23° C./50% relative humidity for 30 min. Then a second adhesive layer is applied by brush. Then the adhesive layer is dried at 23° C./50% relative humidity for a further 60 min.

After the adhesive layer has been dried, the coated canvas substrates, prior to thermal activation and joining, are stored under standard climatic conditions (23° C./50% relative humidity) for different periods (of hours to weeks). The open time is the maximum storage time after which, by the test method described hereinafter, a softening point of 100° C. or higher is still achieved.

The adhesive-coated test specimens are heat-activated with a Funck IR source (2000 shock activation device) for 10 seconds. This increases the surface temperature of the adhesive layer to 90° C. The adhesive bond is established immediately after the thermal activation by pressing the activated adhesive layers together in a press 4 bar for 1 min. The test specimens thus produced are stored under standard climatic conditions (23° C./50% relative humidity) for 1 week.

After the storage period, the test specimens are subjected to a load of 4 kg and heated to 40° C. in a heating cabinet within 30 min. Subsequently, the test specimens are heated to 150° C. at a linear heating rate of 0.5 K/min. The softening point, i.e. the temperature in ° C. at which the adhesive bond fails under a load of 4 kg, is registered. 5 individual measurements were conducted in each case, and the average was determined and reported. (FIG. 1)

### Test Results

TABLE 1
Heat resistances of aqueous adhesive formulations immediately after drying and after storage (softening point measurement)

| | Example No. | | | | | | | | | | | | | | | |
|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 |
| | Example type* | | | | | | | | | | | | | | | |
| | V | V | V | V | V | E | E | V | V | V | E | V | E | E | E | E |
| Raw materials | Amount used in g | | | | | | | | | | | | | | | |
| Dispercoll U 2824 | 100 | 100 | — | — | 50 | 50 | 50 | — | — | 50 | 50 | 50 | 50 | 70 | 30 | 20 |
| Dispercoll U XP 2643 | — | — | 100 | 100 | — | — | — | 50 | 50 | — | — | — | — | — | — | — |
| PU-A-1 | — | — | — | — | 50 | 50 | 50 | 50 | 50 | — | — | — | — | 30 | 70 | 80 |
| PU-A-2 | — | — | — | — | — | — | — | — | — | — | — | 50 | 50 | — | — | — |
| Dispercoll U 42 | — | — | — | — | — | — | — | — | — | 50 | 50 | — | — | — | — | — |
| Uradil FP 9300 | — | — | — | — | — | — | — | — | — | — | — | — | — | — | — | — |
| Desmodur 2802 | — | 14.3 | — | 14.3 | — | 3.6 | 7.1 | — | 7.1 | — | 7.1 | — | 7.1 | 10.0 | 4.3 | 2.9 |
| Picassian XL-725 | — | — | — | — | — | — | — | — | — | — | — | — | — | — | — | — |
| Picassian XL-721 | — | — | — | — | — | — | — | — | — | — | — | — | — | — | — | — |
| NeoAdd PAX-521 | — | — | — | — | — | — | — | — | — | — | — | — | — | — | — | — |
| Softening point [°C] | 49 | 150 | 51 | 146 | 60 | 150 | 150 | 53 | 146 | 56 | 150 | 57 | 146 | 150 | 150 | 150 |
| (joining and thermal | | | | | | | | | | | | | | | | |
| activation directly after | | | | | | | | | | | | | | | | |
| the drying of the | | | | | | | | | | | | | | | | |
| adhesive) | | | | | | | | | | | | | | | | |

Softening point after storage of the precoated substrates at 23 °C/50% rh [°C]*
(joining and thermal activation after storage of the dried adhesive)

| | | | | | | | | | | | | | | | | |
|---|---|---|---|---|---|---|---|---|---|---|---|---|---|---|---|---|
| after storage for 1 hour | — | — | — | 110 | — | — | — | — | 147 | — | — | — | — | — | — | — |
| after storage for 3 hours | — | — | — | 97 | — | 150 | 147 | — | 146 | — | — | — | — | — | — | — |
| after storage for 5 hours | — | — | — | 90 | — | 150 | 147 | — | 146 | — | — | — | — | — | — | — |
| after storage for 24 hours | — | — | — | 62 | — | 150 | 147 | — | 68 | — | — | — | — | — | — | — |
| after storage for 48 hours | — | — | — | — | — | 146 | 147 | — | 68 | — | — | — | — | — | — | — |
| after storage for 1 week | — | 147 | — | — | — | 147 | 146 | — | — | — | 150 | — | 109 | 127 | 136 | 142 |
| after storage for 2 weeks | — | 147 | — | — | — | — | 147 | — | — | — | 147 | — | — | — | — | — |
| after storage for 3 weeks | — | 120 | — | — | — | — | 137 | — | — | — | 147 | — | — | — | — | — |
| after storage for 4 weeks | — | 93 | — | — | — | — | 147 | — | — | — | 150 | — | — | — | — | — |
| after storage for 6 weeks | — | 71 | — | — | — | 149 | 148 | — | — | — | 150 | — | — | — | — | — |
| after storage for 8 weeks | — | 61 | — | — | — | 145 | 150 | — | — | — | 150 | — | — | — | — | — |

Example No.

| | | | | | | | | |
|---|---|---|---|---|---|---|---|---|
| 17 | 18 | 19 | 20 | 21 | 22 | 23 | 24 | 25 |

Example type*

| | | | | | | | | |
|---|---|---|---|---|---|---|---|---|
| V | E | E | V | E | E | E | V | E |

| | |
|---|---|
| Raw materials | Amount used in g |

| | | | | | | | | | |
|---|---|---|---|---|---|---|---|---|---|
| Dispercoll U 2824 | 100 | 50 | 50 | 100 | 50 | 50 | 50 | 50 | 50 |
| Dispercoll U 2643 | — | — | — | — | — | — | — | — | — |
| PU-A-1 | — | 50 | 50 | — | 50 | 50 | 50 | — | — |
| PU-A-2 | — | — | — | — | — | — | — | — | — |
| Dispercoll U 42 | — | — | — | — | — | — | — | — | — |
| Uradil FP 9300 | — | — | — | — | — | — | — | 50 | 50 |
| Desmodur 2802 | — | — | — | — | — | — | — | — | 7.1 |
| Picassian XL-725 | 3.6 | 7.1 | 3.6 | — | — | — | — | — | — |
| Picassian XL-721 | — | — | — | 7.1 | 7.1 | 3.6 | — | — | — |
| NeoAdd PAX-521 | — | — | — | — | — | — | 4.8 | — | — |
| Softening point [°C] | 150 | 150 | 150 | 150 | 150 | 150 | 150 | 51 | 150 |
| (joining and thermal | | | | | | | | | |
| activation directly after | | | | | | | | | |
| the drying of the | | | | | | | | | |
| adhesive) | | | | | | | | | |

Softening point after storage of the precoated substrates at 23 °C/50% rh [°C]*
(joining and thermal activation after storage of the dried adhesive)

| | | | | | | | | | |
|---|---|---|---|---|---|---|---|---|---|
| after storage for 1 hour | — | — | — | — | — | — | — | — | — |
| after storage for 3 hours | — | — | — | — | — | — | — | — | — |
| after storage for 5 hours | — | — | — | — | — | — | — | — | — |
| after storage for 24 hours | — | — | — | — | — | — | — | — | — |
| after storage for 48 hours | — | — | — | — | — | — | — | — | — |
| after storage for 1 week | 150 | 150 | 150 | 150 | 150 | 137 | 150 | — | 150 |
| after storage for 2 weeks | 150 | 132 | 150 | 150 | 150 | 81 | 150 | — | 150 |
| after storage for 3 weeks | 81 | 141 | 142 | 88 | 150 | — | 150 | — | — |
| after storage for 4 weeks | — | 139 | 149 | — | 150 | — | 150 | — | — |
| after storage for 6 weeks | — | 88 | 141 | — | 150 | — | — | — | — |
| after storage for 8 weeks | — | — | 133 | — | 150 | — | — | — | — |

*Inventive examples are identified by E, comparative examples by V.

It is found in Comparative Examples 1, 3, 5, 8, 10, 12 and 24 that both polyurethanes containing carboxyl groups and those not containing carboxyl groups, and also mixtures thereof without use of a polycarbodiimide, or polyaziridines, do not lead to sufficient heat resistances of the adhesive bonds.

It is found with reference to Comparative Example 4 that a combination of an amorphous polymer dispersion containing carboxyl groups with a polycarbodiimide, in the case of immediate heat activation, does lead to adhesive bonds having sufficient heat resistance, but the adhesive films do not show adequate open time on storage under standard conditions. Even after 3 h, the crosslinking of the adhesive films has advanced to such an extent that no adhesive bond with sufficient heat resistance is achieved in the joining process. It is apparent that the already crosslinked polymers at the chosen activation temperature of 90° C. do not have sufficient tack to enter into a heat-resistant adhesive bond with one another.

The same outcome is obtained in Comparative Example 9. It is likewise the case that combination of a semicrystalline polymer dispersion not containing carboxyl groups with an amorphous polymer dispersion containing carboxyl groups and a polycarbodiimide does not achieve a sufficient open time of the adhesive film.

Inventive Example 11, by contrast, shows that a sufficient open time is attained when the polymer not containing carboxyl groups is amorphous but the polymer containing carboxyl groups is semicrystalline.

Comparative Example 2, based exclusively on a polymer dispersion containing carboxyl groups and a polycarbodiimide, does show an open time of more than 3 weeks, but the required use of polycarbodiimide is much higher and the open time is shorter than in Inventive Example 6 or 7.

Comparative Example 17, based exclusively on a polymer dispersion containing carboxyl groups and a polycarbodiimide, does show an open time of more than 2 weeks, but the open time here too is shorter than in Inventive Examples 18 and 19 when the same polycarbodiimide is used.

Inventive Examples 6, 7, 14, 15, 16, 18, 19, 21, 22 and 25 demonstrate that the use of polymer dispersions not containing carbonyl groups and having a high molecular weight in combination with polymer dispersions containing carboxyl groups, even in the case of a small amount of polycarbodiimide, leads to high heat resistances on bonding both immediately after drying of the adhesive and after storage of the dried adhesive layer for 1 week. Accordingly, heat resistances in the case of Inventive Example 13 (polymer dispersion not containing carboxyl groups and having a lower molecular weight) with a comparably high polycarbodiimide content are somewhat lower immediately and after storage for one week.

Example 23 shows that the use of polymer dispersions not containing carbonyl groups and having a high molecular weight in combination with polymer dispersions containing carboxyl groups, even in the case of a small amount of a polyaziridine, leads to high heat resistances on bonding both immediately after drying of the adhesive and after storage of the dried adhesive layer for 1 week.

Example 25 shows that even a combination of a polyester as component A) leads to systems with a reduced polycarbodiimide content and a long open time.

1. An aqueous adhesive formulation in the form of an aqueous dispersion containing at least the following dispersed components:
(A) at least one polymer selected from the group consisting of a polyurethane polymer, a vinyl polymer, a polyester polymer or a mixture of at least two thereof, the at least one polymer having a partial acid number of <1.25 mg KOH/g determined in accordance with DIN EN ISO 2114:2000 (2002-06, Method A with an acetone-ethanol solvent mixture);
(B) at least one semicrystalline or crystalline polyurethane polymer containing carboxyl groups which has a melting temperature in the range of 35 to 80° cand an enthalpy of fusion of ≥15 J/g, each determined by DSC (differential scanning calorimetry) at a heating rate of 20 K/min in accordance with DIN EN ISO 11357-1:2017 (2017-02), and which has a partial acid number of 1.25 mg KOH/g to 25 mg KOH/g, determined in accordance with DIN EN ISO 2114:2000 (2002-06, Method A with an acetone-ethanol solvent mixture);
(C) at least one polycarbodiimide, at least one polyaziridine, or a mixture thereof; and
(D) optionally at least one further polymer other than the at least one polymer (A) and the at least one polyurethane polymer (B).

2. A kit-of-parts for production of an adhesive formulation, comprising the following components:
(A) at least one polymer selected from the group consisting of a polyurethane polymer, a vinyl polymer, a polyester polymer, or a mixture of at least two thereof, the at least one polymer having a partial acid number of <1.25 mg KOH/g determined in accordance with DIN EN ISO 2114:2000 (2002-06, Method A with an acetone-ethanol solvent mixture);
(B) at least one semicrystalline or crystalline polyurethane polymer containing carboxyl groups which has a melting temperature in the range of 35 to 80° cand an enthalpy of fusion of ≥15 J/g, each determined by DSC (differential scanning calorimetry) at a heating rate of 20 K/min in accordance with DIN EN ISO 11357-1:2017 (2017-02), and which has a partial acid number in the range from 1.25 mg KOH/g to 25 mg KOH/g, determined in accordance with DIN EN ISO 2114:2000 (2002-06, Method A with an acetone-ethanol solvent mixture);
(C) at least one polycarbodiimide, at least one polyaziridine, or a mixture thereof; and
(D) optionally at least one further polymer other than the at least one polymer (A) and the at least one polyurethane polymer (B).

3. The aqueous adhesive formulation according to claim 1, wherein the at least one polymer (A) is selected from the group consisting of a polyurethane polymer, a polyacrylate polymer, a polymethacrylate polymer, a polyvinylacetate polymer, a polyester polymer or a mixture of at least two thereof.

4. The aqueous adhesive formulation according to claim 1, wherein the at least one polymer (A) has a partial acid number of 0 mg KOH/g to 1 mg KOH/g, determined in accordance with DIN EN ISO 2114:2000 (2002-06, Method A with an acetone-ethanol solvent mixture).

5. The aqueous adhesive formulation according to claim 1, wherein the average molecular weight (Mw) of polymer (A)≥the average molecular weight (Mw) of polyurethane polymer (B), determined to DIN EN ISO 13885-2 (2021-11) with N,N-dimethylacetamide as eluent and polystyrene as standard.

6. The aqueous adhesive formulation according to claim 1, wherein the at least one polymer (A) has an average molecular weight (Mw) of 70 000 g/mol to 350 000 g/mol, determined in accordance with DIN EN ISO 13885-2 (2021-11) with N,N-dimethylacetamide as eluent and polystyrene as standard.

7. The aqueous adhesive formulation according to claim 1, wherein the at least one polyurethane polymer (B) has an average molecular weight (Mw) of 20 000 g/mol to 300 000 g/mol, determined in accordance with DIN EN ISO 13885-2 (2021-11) with N,N-dimethylacetamide as eluent and polystyrene as standard.

8. The aqueous adhesive formulation according claim 1, wherein the polyurethane polymer (B) has a partial acid number of 2.5 mg KOH/g to 25 mg KOH/g, determined in accordance with DIN EN ISO 2114:2000 (2002-06, Method A with an acetone-ethanol solvent mixture).

9. The aqueous adhesive formulation according claim 1, wherein the aqueous adhesive formulation has a partial acid number of 0.5 mg KOH/g to 10 mg KOH/g, determined in accordance with DIN EN ISO 2114:2000 (2002-06, Method A with an acetone-ethanol solvent mixture).

10. The aqueous adhesive formulation according to claim 1, wherein the at least one polymer (A) has a glass transition temperature of −100° C. to 0° C., determined in accordance with DSC (differential scanning calorimetry) DIN EN ISO 11357-1 (2017-02).

11. The aqueous adhesive formulation according to claim 1, wherein component (C) is at least one polycarbodiimide and has an average molecular weight (Mw) in the range from 500 g/mol to 50 000 g/mol, determined in accordance with DIN EN ISO 13885-2 (2021-11) with N,N-dimethylacetamide as eluent and polystyrene as standard.

12. The aqueous adhesive formulation according claim 1, wherein the at least one component C) is a polycarbodiimide and has a glass transition temperature of −100° C. to 50° C., determined by DSC (differential scanning calorimetry) DIN EN ISO 11357-1 (2017-02).

13. The aqueous adhesive formulation according to claim 1, wherein the molar ratio of carbodiimide groups (—N═C═N—) in component C) to the carboxyl groups (—COOH) in component (B) is from 0.2:1 to 5:1.

14. The aqueous adhesive formulation according to claim 1, wherein the aqueous adhesive formulation contains
(A) 5% by weight to 85% by weight of component (A),
(B) 10% by weight to 70% by weight of component (B),
(C) 1% by weight to 30% by weight of component (C), and
(D) 0% by weight to 30% by weight of component (D),
and the proportions by weight of (A), (B), (C) and (D) add up to 100% by weight.

15. The aqueous adhesive formulation according to claim 1, wherein the sum total of the amounts of components (A), (B), (C) and optionally (D) is at least 30% by weight %, based on the total weight of the aqueous adhesive formulation.

16. The aqueous adhesive formulation according to claim 1, wherein the aqueous adhesive formulation additionally contains at least one additive other than components (A), (B), (C) and (D).

17. A process for producing the aqueous adhesive formulation according to claim 1, comprising:
i) providing components (A), (B), (C), optionally (D), optionally at least one additive and optionally an aqueous medium, where components (A), (B), (C) and optionally (D) may each independently be in the form of an aqueous dispersion, and
ii) mixing the components provided in step i) and the optional at least one additive, and optionally dispersing in an aqueous medium, in order to obtain an aqueous adhesive formulation in the form of an aqueous dispersion.

18. A method of establishing an adhesive bond on at least one substrate, comprising applying the aqueous adhesive formulation according to claim 1 to at least one substrate, allowing the aqueous adhesive composition to dry, and optionally heating the substrate to a temperature of 40° C. to 200° C.

19-20. (canceled)

21. An article produced using the aqueous adhesive formulation of claim 1.
